(19) United States
(12) Patent Application Publication
(10) Pub. No.: US 2008/0300359 A1
(43) Pub. Date: Dec. 4, 2008

(54) AQUEOUS COATING MATERIAL COMPOSITION

(75) Inventors: Satoshi Hoshi, Tokyo (JP); Makoto Fukuda, Ashigarakami-gun (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 12/119,871

(22) Filed: May 13, 2008

(30) Foreign Application Priority Data
May 15, 2007 (JP) P2007-129721

(51) Int. Cl. C08G 77/14; C08G 77/12; C08L 83/00; C08L 83/04

(52) U.S. Cl. 524/588; 528/31; 528/43; 528/10; 525/474; 525/475; 525/477; 525/478

(57) ABSTRACT

An aqueous coating material composition, includes: a hydrophilic polymer that has a hydrophilic group-containing structural unit and at least one hydrolyzable silyl group represented by formula (a) in a main chain terminal or side chain of the hydrophilic polymer, wherein the hydrophilic group-containing structural unit is contained in an amount of 30 mol % or more based on the entire hydrophilic polymer:

—Si(R¹⁰²)ₐ—(OR¹⁰¹)₃₋ₐ Formula (a)
wherein R¹⁰¹ represents a hydrogen atom or an allyl group; R¹⁰² represents a hydrogen atom or a monovalent hydrocarbon group selected from the group consisting of an alkyl group, an aryl group and an aralkyl group; a represents an integer of 0 to 2; and when a plurality of R¹⁰¹'s or R¹⁰²'s are present, the plurality of R¹⁰¹'s or R¹⁰²'s may be the same or different respectively.

### BACKGROUND OF THE INVENTION

1. Field of the Invention

The present invention relates to an aqueous coating material composition. More specifically, the present invention relates to an aqueous coating material composition excellent in the adhesive property to various substrates, capable of giving a coating film excellent in the water resistance, antifouling property, weather resistance, scratch resistance, abrasion resistance, initial hydrophilicity and cracking prevention, and assured of excellent dispersion stability and high storage stability of the aqueous coating material composition.

2. Description of the Related Art

Conventionally, a coating finish is applied for the frame protection, ornamentation or aesthetic enhancement of a building, a civil engineering structure, an automobile or the like. In particular, with the recent advent of a high-durability coating material such as fluororesin coating material, acryl silicon resin coating material and polyurethane resin coating material, the performance in terms of frame protection has made a great progress. However, because of the characterstics inherent in the resin, the surface of a coating film formed of such a high-durability coating material is generally hydrophobic or lipophilic. Accordingly, oil or the like when attached as a contaminant to the surface cannot be easily removed or due to its accumulation, the function or property of the product or member having this surface sometimes seriously deteriorates. In the case of a product or member exposed to high-humidity conditions or rainfall, the attachment of water drops brings about a problem that the light transparency of a product or member having a transparent function is inhibited by the diffused reflection of light. Also, as regards a product or member having an inorganic surface such as glass or metal, the antifouling property against attachment of a contaminant such as oil is insufficient, and the antifogging property against attachment of water drops is not satisfied, either. Particularly, the automobile glass or building glass is in many cases subject to attachment of urban soot or dust, a combustion product such as carbon black contained in an exhaust gas of automobiles or the like, or a hydrophobic contaminant such as grease or sealant eluting component, or to attachment of water drops, making it difficult to secure the field of vision through the glass, and it is strongly demanded to impart an antifouling or antifogging function.

In view of the antifouling property, envisaging that the contaminant is an organic substance such as oil, it is necessary for preventing the contamination to reduce the interaction with the material surface, that is, impart hydrophilicity or oil repellency. Also, in view of the antifogging property, it is necessary to impart expanded wettability of evenly spreading the attached water drops on the surface (that is, hydrophilicity) or impart water repellency facilitating the removal of attached water drops. For these reasons, many of antifouling or antifogging materials under study at present rely on the endowment of hydrophilicity or water/oil repellency.

According to a conventionally proposed surface treatment for imparting hydrophilicity, such as etching treatment and plasma treatment, hydrophilization to a high level may be attained, but the effect is temporary and the hydrophilic state cannot be maintained for a long time. Also, a surface hydrophilic coating film using a hydrophilic graft polymer is proposed as one of hydrophilic resins, but this coating film is insufficient in the affinity for the substrate, despite a certain level of hydrophilicity, and higher durability is demanded.

As for other members having a surface hydrophilic function, those utilizing titanium oxide as a photocatalyst have been conventionally known. This technique is based on the oxidative decomposition function and hydrophilization function of an organic material, which are exerted upon irradiation of light. For example, International Publication No. 96/29375, pamphlet discloses that when a photocatalyst-containing layer is formed on the surface of a substrate, the surface is hydrophilized to a high level according to the photoexcitation of the photocatalyst, and it is reported that when this technique is applied to various composites such as glass, lens, mirror, external material and member in water circumstances, an excellent antifogging or antifouling function or the like can be imparted to the composite. A member obtained by coating titanium oxide on the glass surface is used as a self-cleaning material on the architectural window glass or vehicle front glass but must be exposed to sunlight for a long time so as to exert the antifouling or antifogging function, and its property is inevitably deteriorated due to accumulated contamination with long-term aging. Furthermore, the film strength is insufficient, and enhancement of durability is necessary. Also, a self-cleaning film obtained by providing a titanium oxide layer on a plastic substrate is being used for a vehicle side mirror or the like but fails in having a sufficiently high film strength, and a hydrophilic material having higher abrasion resistance is demanded.

As for the antifouling or antifogging material based on water repellency or oil repellency, a silicone compound or a fluorine compound is mainly used. For example, there are disclosed an antifouling material obtained by coating a silanol-terminated organopolysiloxane on the substrate surface in JP-A-4-338901 (the term “JP-A” as used herein means an “unexamined published Japanese patent application”), a material containing a silane compound having a polyfluoroalkyl group in JP-B-6-29332 (the term “JP-B” as used herein means an “examined Japanese patent publication”), and a combination of an optical thin film mainly comprising silicon dioxide with a copolymer of perfluoroacrylate and an alkoxysilane group-containing monomer in JP-A-7-16940. However, these antifouling materials using a silicone compound or a fluorine compound are insufficient in the antifouling property, and the contamination such as fingerprint, grease, sweat and cosmetic can be hardly removed. Moreover, the surface treatment with a compound having a low surface energy, such as fluorine and silicone, may cause reduction in the function with aging, and it is demanded to develop an antifouling or antifogging member with excellent durability.

On the other hand, JP-A-7-11152 proposes, for example, a curable composition containing a silyl group-containing emulsion or water-soluble resin, an epoxy group-containing compound and an organic aluminum compound. However, the coating film obtained from such a curable composition cannot have a sufficiently high hydrophilic surface and is poor in the water resistance, contamination resistance and weather resistance. More improvements are demanded.

### SUMMARY OF THE INVENTION

An object of the present invention is to provide an aqueous coating material composition excellent in the adhesive property to various substrates, capable of giving a coating film excellent in the water resistance, antifouling property, weather resistance, scratch resistance, abrasion resistance, initial hydrophilicity and cracking prevention, and assured of excellent dispersion stability and high storage stability of the aqueous coating material composition.

The present invention is as follows.

(1) An aqueous coating material composition, comprising:

a hydrophilic polymer that has a hydrophilic group-containing structural unit and at least one hydrolyzable silyl group represented by formula (a) in a main chain terminal or side chain of the hydrophilic polymer,

wherein the hydrophilic group-containing structural unit is contained in an amount of 30 mol % or more based on the entire hydrophilic polymer:

—Si(R¹⁰²)ₐ—(OR¹⁰¹)₃₋ₐ Formula (a)

wherein R¹⁰¹ represents a hydrogen atom or an alkyl group; R¹⁰² represents a hydrogen atom or a monovalent hydrocarbon group selected from the group consisting of an alkyl group, an aryl group and an aralkyl group;

a represents an integer of 0 to 2; and

when a plurality of R¹⁰¹'s or R¹⁰²'s are present, the plurality of R¹⁰¹'s or R¹⁰²'s may be the same or different, respectively.

(2) The aqueous coating material composition as described in (1) above,

wherein the hydrophilic polymer is a hydrophilic polymer that has at least one structure represented by formula (I), (II) or (IV):

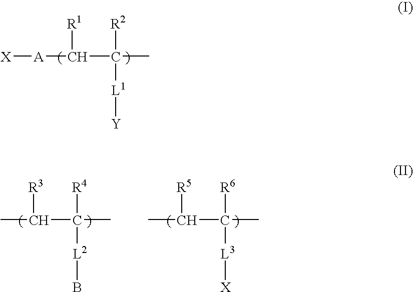

wherein R¹, R², R³, R⁴, R⁵ and R⁶ each independently represents a hydrogen atom or a hydrocarbon group;

X represents a hydrolyzable silyl group represented by formula (a);

A, L¹, L² and L³ each independently represents a single bond or a linking group;

Y represents —NHCOR⁷, —CONH₂, —CON(R⁷)₂, —COR⁷, —OH, —CO₂M, —SO₃M, —PO₃M, —OPO₃M or —N(R⁷)₃Z¹, in which R⁷ represents an alkyl group, an aryl group or an aralkyl group, M represents a hydrogen atom, an alkali metal, an alkaline earth metal or an onium, and Z¹ represents a halogen ion; and

B represents a group having a structure represented by formula (III):

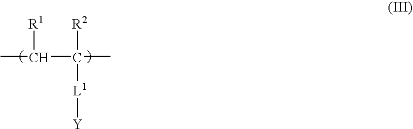

wherein R¹, R², L¹ and Y have the same meanings as in formulae (I) and (II):

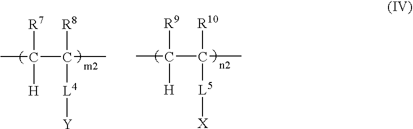

wherein R⁷, R⁸, and R¹⁰ each independently represents a hydrogen atom or a hydrocarbon group;

L⁴ and L⁵ each independently represents a single bond or a linking group;

Y and X have the same meanings as in formulae (I) and (II); and

m2 and n2 define a compositional ratio of respective structures when m2+n2=100, provided that m2≧30.

(3) The aqueous coating material composition as described in (2) above,

wherein L⁵ in formula (IV) represents a single bond or a linking group having one or more structure(s) selected from the group consisting of —CONH—, —NHCONH—, —OCONH—, —SO₂NH— and —SO₃—.

(4) The aqueous coating material composition as described in any of (1) to (3) above, further comprising:

at least one of a crosslinking agent and a curing catalyst.

(5) The aqueous coating material composition as described in (4) above,

wherein the curing catalyst is a metal complex.

(6) The aqueous coating material composition as described in (4) or (5) above,

wherein the crosslinking agent is a metal alkoxide compound.

(7) The aqueous coating material composition as described in any of (1) to (6) above, further comprising:

particles.

(8) The aqueous coating material composition as described in (7) above,

wherein the particles have a particle diameter of from 0.01 to 10 μm.

(9) The aqueous coating material composition as described in (7) or (8) above,

wherein the particles are a pigment.

(10) The aqueous coating material composition as described in any of (1) to (9) above, further comprising:

an antifreezing agent.

(11) The aqueous coating material composition as described in any of (1) to (10) above,

wherein the hydrophilic group-containing structural unit accounts for 40 to 95 mol % of the entire hydrophilic polymer.

(12) The aqueous coating material composition as described in any of (1) to (11) above,

wherein the hydrophilic polymer is a hydrophilic polymer represented by formula (V):

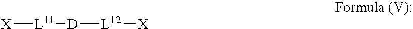

wherein X represents a hydrolyzable silyl group represented by formula (a);

L¹¹ and L¹² each independently represents a divalent linking group having three or more kinds of atoms selected from the group consisting of a carbon atom, a hydrogen atom, an oxygen atom, a nitrogen atom and a sulfur atom; and

D represents a polymer or oligomer where structural units each independently forms a repeating structure.

(13) The aqueous coating material composition as described in any of (6) to (12) above,

wherein a metal in the metal alkoxide compound is selected from the group consisting of Si, Ti, Zr and Al.

(14) The aqueous coating material composition as described in any of (6) to (13) above,

wherein the metal alkoxide compound is represented by formula (VI-1) or (VI-2):

(R⁸)ₘ-Z-(OR⁹)₄₋ₘ (VI-1)

Al—(OR⁹)₃ (VI-2)

wherein R⁸ represents a hydrogen atom, an alkyl group or an aryl group;

R⁹ represents an alkyl group or an aryl group;

Z represents Si, Ti or Zr; and

m represents an integer of 0 to 2.

### DETAILED DESCRIPTION OF THE INVENTION

The present invention is described in detail below,

### [Hydrolyzable Silyl Group-Containing Hydrophilic Polymer]

The aqueous coating material composition of the present invention contains a hydrolyzable silyl group-containing hydrophilic polymer (hereinafter sometimes simply referred to as a “hydrophilic polymer”).

The hydrophilic polymer for use in the present invention has a hydrophilic group-containing structural unit and a molecule containing at least one hydrolyzable silyl group represented by formula (a) in a main chain terminal or side chain of the polymer. Also, the hydrophilic group-containing structural unit is contained in an amount of 30 mol % or more based on the entire hydrophilic polymer.

—Si(R¹⁰²)ₐ—(OR¹⁰¹)₃₋ₐ Formula (a)

(wherein R¹⁰¹ represents a hydrogen atom or an alkyl group, R¹⁰² represents a hydrogen atom or a monovalent hydrocarbon group selected from the group consisting of an alkyl group, an aryl group and an aralkyl group, a represents an integer of 0 to 2, and when a plurality of R¹⁰¹'s or R¹⁰²'s are present, these may be the same or different).

R¹⁰¹ is preferably an alkyl group having a carbon number of 1 to 10 when it represents an alkyl group. R¹⁰² is preferably an alkyl group having a carbon number of 1 to 10 when it represents an alkyl group; preferably an aryl group having a carbon number of 6 to 25 when it represents an aryl group; and preferably an aralkyl group having a carbon number of 7 to 12 when it represents an aralkyl group.

The hydrolyzable silyl group is preferably a hydrolyzable silyl group bonded to a carbon atom.

The hydrophilic group-containing structural unit is preferably contained in am amount of 40 to 95 mol % based on the entire hydrophilic polymer.

The hydrophilic polymer for use in the present invention has a hydrophilic group. As the hydrophilic group, a functional group such as a carboxyl group, an alkali metal salt of carboxyl group, a sulfonic acid group, an alkali metal salt of sulfonic acid group, a hydroxy group, an amide group, a carbamoyl group, a sulfonamide group and a sulfamoyl group is exemplified. Such a group may be present at any position in the polymer. A polymer structure where the hydrophilic group is bonded to the polymer main chain directly or through a linking group or bonded in the polymer side chain or graft side chain and a plurality of hydrophilic groups are present, is preferred.

Also, the hydrophilic polymer for use in the present invention is preferably a polymer having a group capable of forming a bond with an alkoxide containing an element selected from Si, Ti, Zr and Al (sometimes referred to as a “metal alkoxide compound”), which is described later, under the action of a catalyst or the like. The group capable of forming a bond with a metal alkoxide compound under the action of a catalyst includes, in addition to the hydrolyzable silyl group represented by formula (a), a reactive group, and examples thereof include a carboxyl group, an alkali meta salt of carboxyl group, a carboxylic acid anhydride group, an amino group, a hydroxy group, an epoxy group, a methylol group, a mercapto group, an isocyanate group, a block isocyanate group, an alkoxysilyl group, an alkoxy titanate group, an alkoxy aluminate group, an alkoxy zirconate group, an ethylenically unsaturated group, an ester group and a tetrazole group. The polymer structure having a hydrophilic group and a group capable of forming a bond with a metal alkoxide compound under the action of a catalyst or the like is preferably a polymer produced by the vinyl polymerization of an ethylenically unsaturated group (e.g., acrylate, methacrylate, itaconic acid, crotonic acid, cinnamic acid, styrene, vinyl, allyl, vinyl ether, vinyl ester), a polymer produced by the condensation-polymerization, such as polyester, polyamide and polyamic acid, a polymer produced by the addition polymerization, such as polyurethane, or a cyclic polymer structure of natural product, such as cellulose, amylose and chitosan.

The hydrophilic polymer for use in the present invention preferably has a structure represented by the following formula (I) or (II):

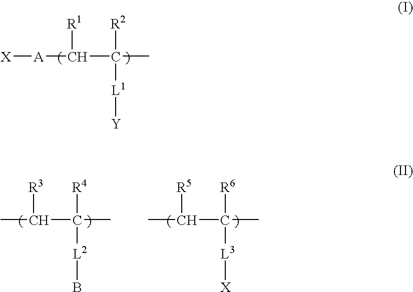

In formulae (I) and (II), R¹, R², R³, R⁴, R⁵ and R⁶ each independently represents a hydrogen atom or a hydrocarbon group (preferably a hydrocarbon group having a carbon number of 1 to 8), X represents a hydrolyzable silyl group represented by formula (a) (hereinafter sometimes referred to as a “reactive group”), A, L¹, L² and L³ each independently represents a single bond or a linking group, Y represents —NHCOR⁷, —CONH₂—CON(R⁷)₂, —COR⁷, —OH, —CO₂M, —SO₃M, —PO₃M, —OPO₃M or —N(R⁷)₃Z¹ (wherein R⁷ represents an alkyl, aryl or aralkyl group preferably having a carbon number of 1 to 18, M represents a hydrogen atom, an alkali metal, an alkaline earth metal or an onium, and Z¹ represents a halogen ion), and B represents a group having a structure represented by the following formula (III):

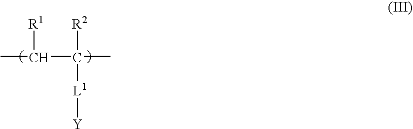

In formula (III), the definitions of R¹, R², L¹ and Y are the same as those in formulae (I) and (II).

The hydrophilic polymer for use in the present invention has a reactive group and a hydrophilic group as described above. As for the reactive group, there is a case where the polymer has one reactive group or a plurality of reactive groups at the terminal of the main chain or a case where the polymer has one reactive group or a plurality of reactive groups in the side chain.

The “reactive group” can react with a hydrolyzed polycondensate of metal alkoxide to form a chemical bond. Also, the reactive groups may form a chemical bond with each other. The hydrophilic polymer is preferably water-soluble and preferably becomes water-insoluble resulting from reaction with a hydrolyzed polycondensate of metal alkoxide.

The chemical bond includes, similarly to the normal meaning, a covalent bond, an ionic bond, a coordinate bond, and a hydrogen bond. The chemical bond is preferably a covalent bond.

The hydrophilic polymer may have two or more reactive groups at one terminal. These two or more reactive groups may be the same or different.

A linking group preferably intervenes between a repeating unit and a reactive group of the hydrophilic polymer or between a repeating unit and the main chain of the hydrophilic polymer. The linking groups A, L¹, L² and L³ each is independently a single bond or a linking group described below or is preferably selected from —N<, an aliphatic group, an aromatic group, a heterocyclic group and a combination thereof. The linking group is preferably —O—, —S—, —CO—, —NH— or a combination containing —O—, —S—, —CO— or —NH—.

### (Polymer Represented by Formula (I))

The polymer represented by formula (I) can be synthesized, for example, by radical-polymerizing a hydrophilic monomer (for example, acrylamide, acrylic acid or a potassium salt of 3-sulfopropyl methacrylate) in the presence of a chain transfer agent (described in Kanji Kamachi and Tsuyoshi Endo, Radical Jugo Handbook (Radical Polymerization Handbook), NTS) or an iniferter (described in Otsu, Macromolecules, 19, page 287 et seq. (1986)). Examples of the chain transfer agent include 3-mercaptopropionic acid, 2-aminoethanethiol hydrochloride, 3-mercaptopropanol, 2-hydroxyethyldisulfide and 3-mercaptopropyltrimethoxysilane. Also, a hydrophilic monomer (e.g., acrylamide) may be radical-polymerized using a radial polymerization initiator having a reactive group without using a chain transfer agent.

The mass average s molecular weight of the polymer represented by formula (I) is preferably 1,000,000 or less, more preferably from 1,000 to 1,000,000, and most preferably from 2,000 to 100,000.

The polymer represented by formula (I) is a hydrophilic polymer having a reactive group at the terminal. In formula (I), R¹ and R² each independently represents a hydrogen atom or a hydrocarbon group. Examples of the hydrocarbon group include an alkyl group and an aryl group, and a linear, branched or cyclic alkyl group having a carbon number of 8 or less is preferred. Specific examples thereof include a methyl group, an ethyl group, a propyl group, a butyl group, a pentyl group, a hexyl group, a heptyl group, an octyl group, an isopropyl group, an isobutyl group, an s-butyl group, a tert-butyl group, an isopentyl group, a neopentyl group a 1-methylbutyl group, an isohexyl group, a 2-ethylhexyl group, a 2-methylhexyl group, and a cyclopentyl group. In view of the effect and easy availability, R¹ and R² each is preferably a hydrogen atom, a methyl group or an ethyl group.

These hydrocarbon groups each may further have a substituent. When the alkyl group has a substituent, the substituted alkyl group is constituted by the bonding of the substituent to an alkylene group, and the substituent used here is a monovalent nonmetallic atomic group excluding hydrogen. Preferred examples thereof include a halogen atom (—F, —Br, —Cl, —I), an alkoxy group, an aryloxy group, an alkylthio group, an arylthio group, an N-alkylamino group, an N,N-dialkylamino group, an acyloxy group, an N-alkylcarbamoyloxy group, an N-arylcarbamoyloxy group, an acylamino group, a formyl group, an acyl group, a carboxyl group, an alkoxycarbonyl group, an aryloxycarbonyl group, a carbamoyl group, an N-alkylcarbamoyl group, an N,N-dialkylcarbamoyl group, an N-arylcarbamoyl group, an N-alkyl-N-arylcarbamoyl group, a sulfo group, a sulfonato group, a sulfamoyl group, an N-alkylsulfamoyl group, an N,N-dialkylsulfamoyl group, an N-arylsulfamoyl group, an N-alkyl-N-arylsulfamoyl group, a phosphono group, a phosphonato group, a dialkylphosphono group, a diarylphosphono group, a monoalkylphosphono group, an alkylphosphonato group, a monoarylphosphono group, an arylphosphonato group, a phosphonoxy group, a phosphonatoxy group, an aryl group, and an alkenyl group.

The alkylene group in the substituted alkyl group includes a divalent organic residue obtained by removing any one hydrogen atom on the above-described alkyl group having a carbon number of 1 to 8 and is preferably a linear alkylene group having a carbon number of 1 to 12, a branched alkylene group having a carbon number of 3 to 12, or a cyclic alkylene group having a carbon number of 5 to 10. Preferred specific examples of the substituted alkyl group obtained by combining the substituent with an alkylene group include a chloromethyl group, a bromomethyl group, a 2-chloroethyl group, a trifluoromethyl group, a methoxymethyl group, a methoxyethoxyethyl group, an allyloxymethyl group, a phenoxymethyl group, a methylthiomethyl group, a tolylthiomethyl group, an ethylaminoethyl group, a diethylaminopropyl group, a morpholinopropyl group, an acetyloxymethyl group, a benzoyloxymethyl group, an N-cyclohexylcarbamoyloxyethyl group, an N-phenylcarbamoyloxyethyl group, an acetylaminoethyl group, an N-methylbenzoylaminopropyl group, a 2-oxyethyl group, a 2-oxypropyl group, a carboxypropyl group, a methoxycarbonylethyl group, an allyloxycarbonylbutyl group, a chlorophenoxycarbonylmethyl group, a carbamoylmethyl group, an N-methylcarbamoylethyl group, an N,N-dipropyl-carbamoylmethyl group, an N-(methoxyphenyl)carbamoylethyl group, an N-methyl-N-(sulfophenyl)carbamoylmethyl group, a sulfobutyl group, a sulfonatobutyl group, a sulfamoylbutyl group, an N-ethylsulfamoylmethyl group, an N,N-dipropylsulfamoylpropyl group, an N-tolylsulfamoylpropyl group, an N-methyl-N-(phosphonophenyl)sulfamoyloctyl group, a phosphonobutyl group, a phosphonatohexyl group, a diethylphosphonobutyl group, a diphenylphosphonopropyl group, a methylphosphonobutyl group, a methylphosphonatobutyl group, a tolylphosphonohexyl group, a tolylphosphonatohexyl group, a phosphonoxypropyl group, a phosphonatoxybutyl group, a benzyl group, a phenethyl group, an α-methylbenzyl group, a 1-methyl-1-phenylethyl group, a p-methylbenzyl group, a cinnamyl group, an allyl group, a 1-propenylmethyl group, a 2-butenyl group, a 2-methylallyl group, a 2-methylpropenylmethyl group, a 2-propynyl group, a 2-butynyl group, and a 3-butynyl group.

A and L¹ each represents a single bond or an organic linking group. Here, when A and L¹ each represents au organic linking group, A and L¹ each is a polyvalent linking group composed of nonmetallic atoms, specifically a linking group composed of from 0 to 60 carbon atoms, from 0 to 10 nitrogen atoms, from 0 to 50 oxygen atoms, from 0 to 100 hydrogen atoms and from 0 to 20 sulfur atoms. More specific examples of the linking group include those comprising one of the following structural units or a combination thereof.

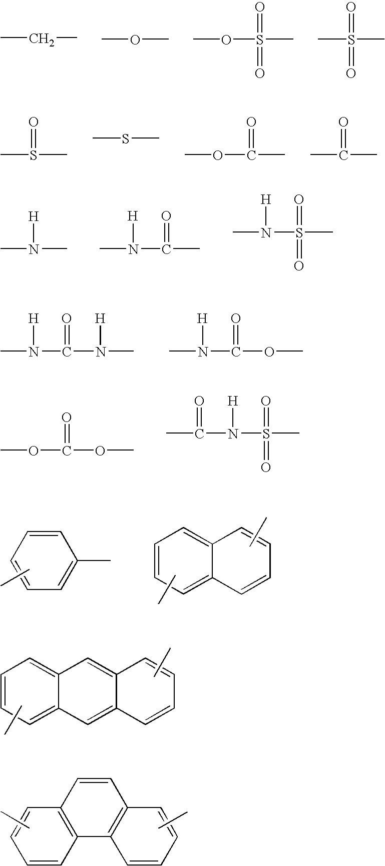

Y represents —NHCOR⁷, —CONH₂, —CON(R⁷)₂, —COR⁷, —OH, —CO₂M, —SO₃M, —PO₃M, —OPO₃M or —N(R⁷)₃Z¹, wherein R⁷ preferably represents a linear, branched or cyclic alkyl aryl or aralkyl group having a carbon number of 1 to 18, M represents a hydrogen atom, an alkali metal, an alkaline earth metal or an onium, and Z¹ represents a halogen ion. In the case of having a plurality of R⁷'s as in —CON(R⁷)₂, R⁷'s may combine with each other to form a ring. The ring formed may be a hetero ring containing a heteroatom such as oxygen atom, sulfur atom and nitrogen atom. R⁷ may further have a substituent, and examples of the substituent which can be introduced here are the same as those of the substituent which can be introduced when R¹ and R² each is an alkyl group.

Specific preferred examples of R⁷ include a methyl group, an ethyl group, a propyl group, a butyl group, a pentyl group, a hexyl group, a heptyl group, an octyl group, an isopropyl group, an isobutyl group, an s-butyl group, a tert-butyl group, an isopentyl group, a neopentyl group, a 1-methylbutyl group, an isohexyl group, a 2-ethylhexyl group, a 2-methylhexyl group, and a cyclopentyl group, M is a hydrogen atom, an alkali metal such as lithium, sodium and potassium, an alkaline earth metal such as calcium and barium, or an onium such as ammonium, iodonium and sulfonium. Specific preferred examples of Y include —NHCOCH₃, —CONH₂, —COOH, —SO₃⁻NMe₄⁺ and a morpholyl group.

Specific examples (Compounds 1 to 13) of the hydrophilic polymer represented by formula (I) which can be suitably used in the present invention are set forth below, but the present invention is not limited thereto.

| | | Mass Average | Mol % of Hydrophilic |
|---|---|---|---|
| | | Molecular Weight | Group Structural Unit |
| 1 | 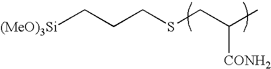 | 5,000 | 99% |
| 2 | 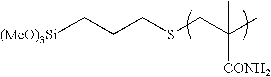 | 6,000 | 99% |
| 3 | 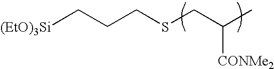 | 10,000 | 99% |
| 4 | 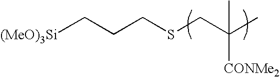 | 8,000 | 98% |
| 5 | 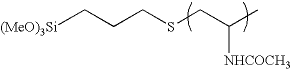 | 15,000 | 99% |
| 6 | 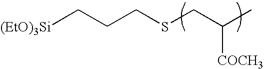 | 10,000 | 99% |
| 7 | 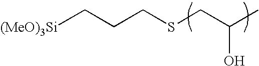 | 30,000 | 99% |
| 8 | 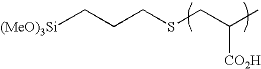 | 5,000 | 99% |
| 9 | 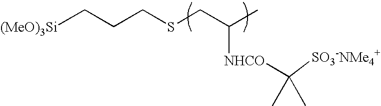 | 10,000 | 97% |
| 10 | 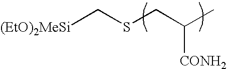 | 20,000 | 99% |
| 11 | 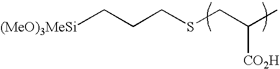 | 7,000 | 99% |
| 12 | 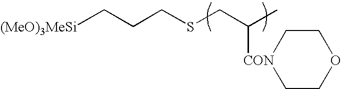 | 15,000 | 99% |
| 13 | 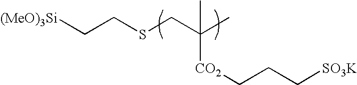 | 5,000 | 95% |

The hydrophilic polymers above can be synthesized by radical polymerization using a radical-polymerizable monomer represented by the following formula (i) and a silane coupling agent represented by the following formula (ii) having a chain transfer function for the radical polymerization. By virtue of the chain transfer function of the silane coupling agent (ii), in the radical polymerization, a polymer where a silane coupling group is introduced into the terminal of the polymer main chain can be synthesized.

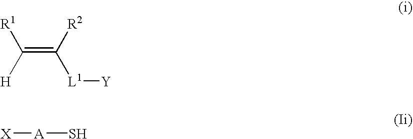

In formulae (i) and (ii), A R¹, R², L¹, X and Y have the same meanings as in formula (I). These compounds are commercially available or can be easily synthesized. The radical-polymerizable monomer represented by formula (i) has a hydrophilic group Y, and this monomer works out to one structural unit in the hydrophilic polymer.

### (Polymer Represented by Formula (II))

A hydrophilic graft polymer obtained by introducing a hydrophilic group-containing side chain into the trunk polymer having a reactive group can be used as a polymer represented by formula (II), that is, a hydrophilic polymer having a plurality of reactive groups.

In formula (II), R³, R⁴, R⁵ and R⁶ each independently has the same meaning as R¹ and R² in formula (I), and specific examples and preferred ranges are also the same. L² and L³ have the same meaning as L¹ in formula (I), and specific examples and preferred ranges are also the same. B has a group having a structure represented by formula (III). In formula (III), R¹, R², L¹ and Y have the same meanings as those in formula (I) and (II), and specific examples and preferred ranges are also the same. X has the same meaning as X in formula (I), and specific examples and preferred range are also the same.

This hydrophilic graft polymer can be prepared by a method generally known as a synthesis method of graft polymers. The general synthesis methods of graft polymers are specifically described in Fumio Ide, Graft Jugo to Sono Oyo (Graft Polymerization and its Application), Kobunshi Kanko Kai (1977), and Shin Kobunshi Jikken Gaku 2, Kobunshi no Gosei•Hanno (New Polymer Experimentation 2, Synthesis and Reaction of Polymers), compiled by Polymer Society Japan, Kyoritsu Shuppan (1995), and these can be applied.

The synthesis method of a graft polymer is fundamentally classified into three methods of 1. polymerizing a branch monomer from a trunk polymer, 2. bonding a branch polymer to a trunk polymer, and 3. copolymerizing a branch polymer to a trunk polymer (macromer method). The hydrophilic graft polymer for use in the present invention can be produced by using any of these three methods, but in view of suitability for the production and control of the film structure, the “3, macromer method” is excellent.

The synthesis of a graft polymer using a macromonomer is described in Shin Kobunshi Jikken Gaku 2, Kobunshi no Gosei•Hanno (New Polymer Experimentation 2, Synthesis and Reaction of Polymers), compiled by Polymer Society Japan, Kyoritsu Shuppan (1995), supra, and also described in detail in Yu Yamashita et al., Macromonomer no Kagaku to Kogyo (Chemistry and Industry of Macromonomers), IPC (1989). The graft polymer for use in the present invention can be synthesized by synthesizing a hydrophilic macromonomer (corresponding to a precursor of the hydrophilic polymer side chain) according to the above-described method and then copolymerizing the macromonomer with a reactive group-containing monomer.

### (Hydrophilic Macromonomer)

Of the hydrophilic macromonomers for use in the present invention, particularly useful are a macromonomer derived from a carboxyl group-containing monomer such as acrylic acid and methacrylic acid; a sulfonic acid-based macromonomer derived from a monomer such as 2-acrylamide-2-methylpropanesulfonic acid, vinylstyrenesulfonic acid and a salt thereof; an amide-based macromonomer such as acrylamide and methacrylamide; an amide-based macromonomer derived from an N-vinylcarboxylic acid amide monomer such as N-vinylacetamide and N-vinylformamide; a macromonomer derived from a hydroxyl group-containing monomer such as hydroxyethyl methacrylate, hydroxyethyl acrylate and glycerol monomethacrylate; and a macromonomer derived from an alkoxy group- or ethylene oxide group-containing monomer such as methoxyethyl acrylate, methoxypolyethylene glycol acrylate and polyethylene glycol acrylate. In addition, a monomer having a polyethylene glycol chain or a polypropylene glycol chain may also be advantageously used as the macromonomer for use in the present invention. Out of these macromonomers, the mass average molecular weight (hereinafter simply referred to as a “molecular weight”) of useful polymers is from 400 to 100,000, preferably from 1,000 to 50,000, more preferably from 1,500 to 20,000. When the molecular weight is 400 or more, effective hydrophilicity can be obtained, and when the molecular weight is 100,000 or less, the polymerizability with a copolymerization monomer forming the main chain tends to increase. Both are preferred.

As for the graft polymer, a graft polymer having a mass average molecular weight of 1,000,000 or less is preferred, and the molecular weight is preferably from 1,000 to 1,000,000, more preferably from 20,000 to 100,000. When the molecular weight is 1,000,000 or less, the solubility in a solvent at the time of preparing a coating solution for the formation of a hydrophilic film is not worsened and this is advantageous in that the viscosity of the coating solution becomes low and there arises no problem in the handleability, for example, a uniform film can be easily formed.

The hydrophilic polymer has a hydrophilic functional group exhibiting hydrophilicity, which is represented by Y in the formula, and the density of this functional group is preferably as high as possible because the surface hydrophilicity increases. The density of the hydrophilic functional group can be expressed by the molar number of functional group per g of the hydrophilic polymer and is preferably from 1 to 30 meq/g, more preferably from 2 to 20 meq/g, and most preferably from 3 to 15 meq/g.

The copolymerization ratio of the hydrophilic polymer (II) can be arbitrarily set such that the amount of the hydrophilic functional group Y falls in the above-described range. The molar ratio (m) of the monomer containing B and the molar ratio (n) of the monomer containing X are preferably in the range of m/n=30/70 to 99/1, more preferably m/n=40/60 to 98/2, and most preferably m/n 50/50 to 97/3. When m is a ratio of m/n=30/70 or more, hydrophilicity is not lacking, whereas when n is a ratio of m/n=99/1 or more, the amount of the reactive group is enough and satisfactory curing as well as sufficiently high film strength are obtained.

Specific examples of the hydrophilic polymer represented by formula (II), which can be suitably used in the present invention, are set forth below, but the present invention is not limited thereto.

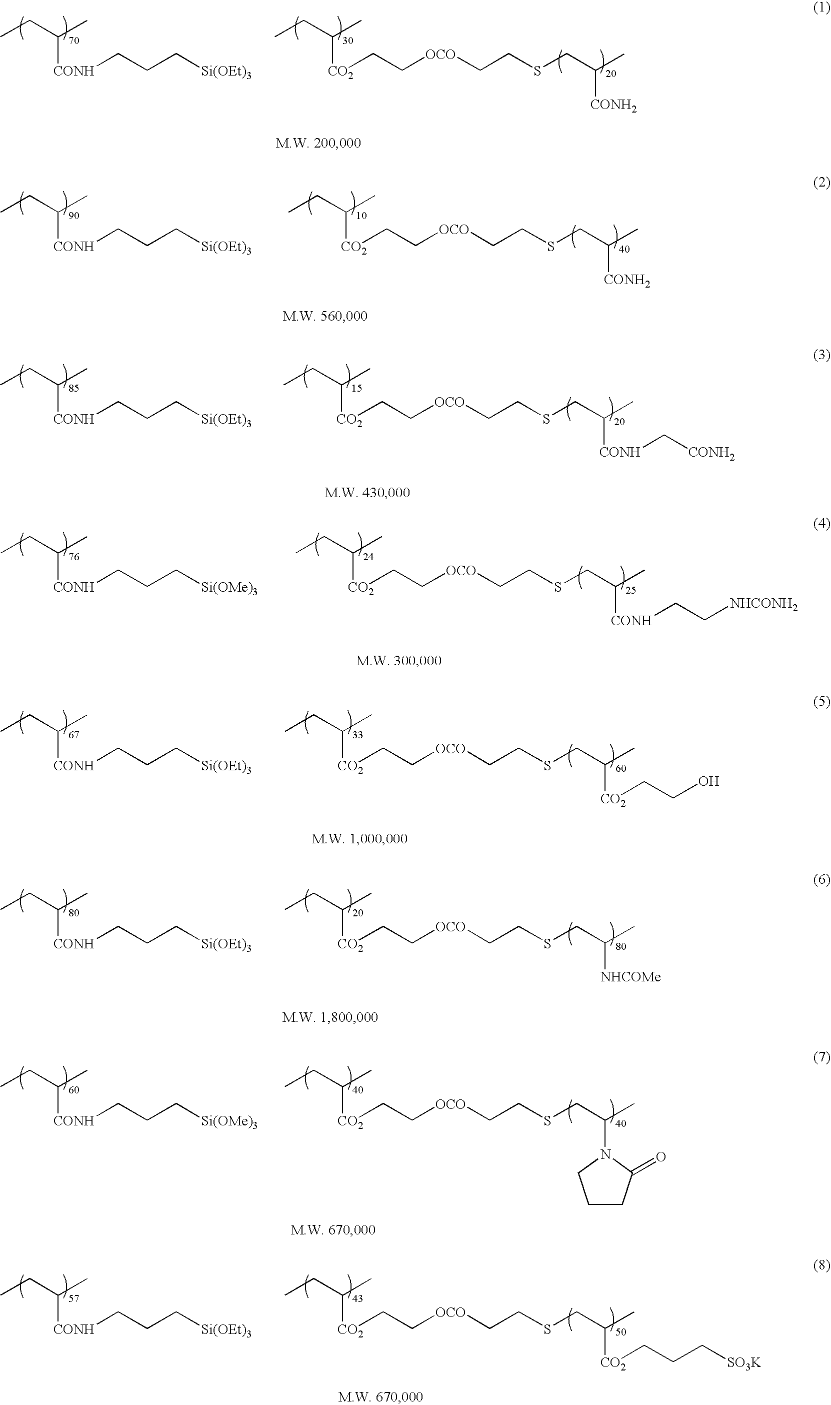

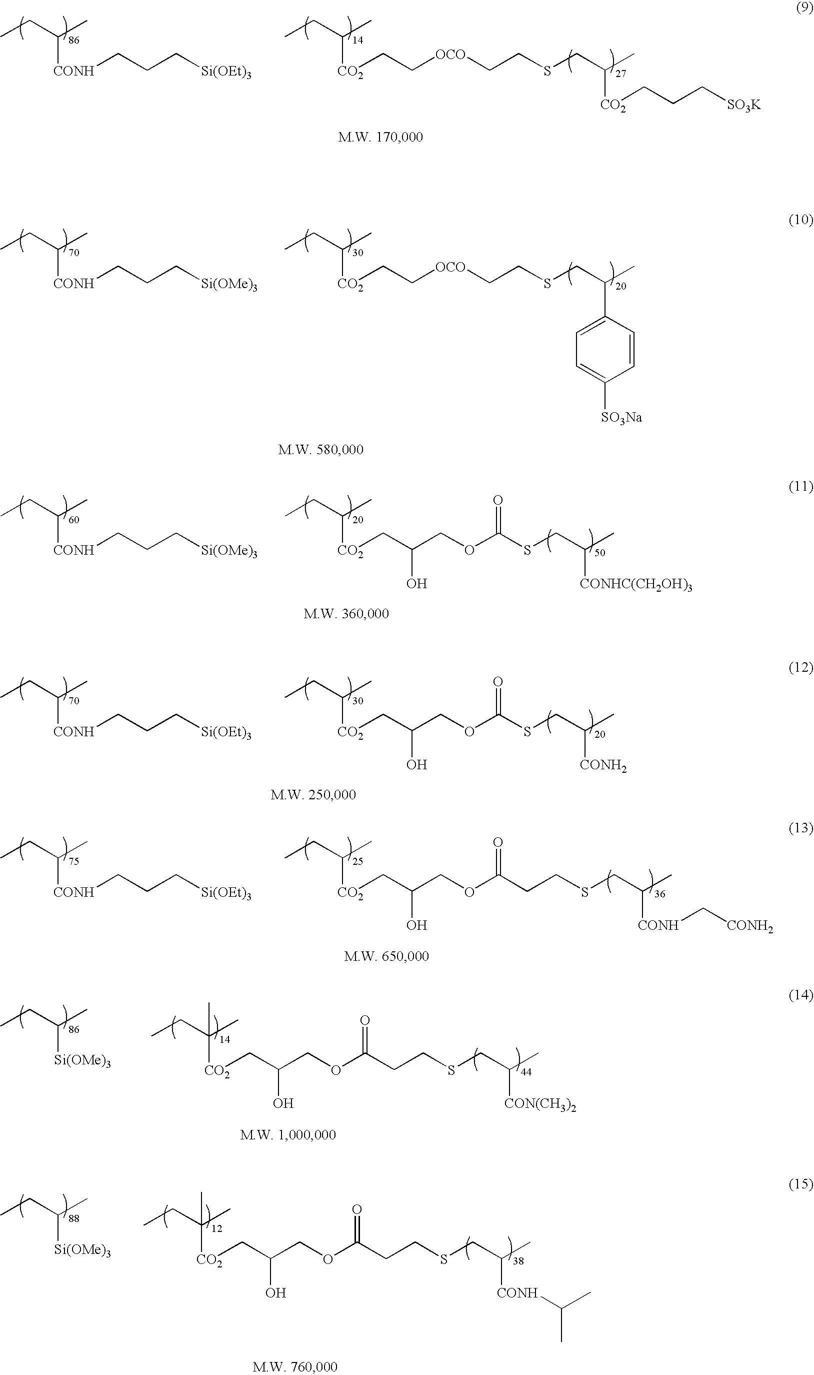

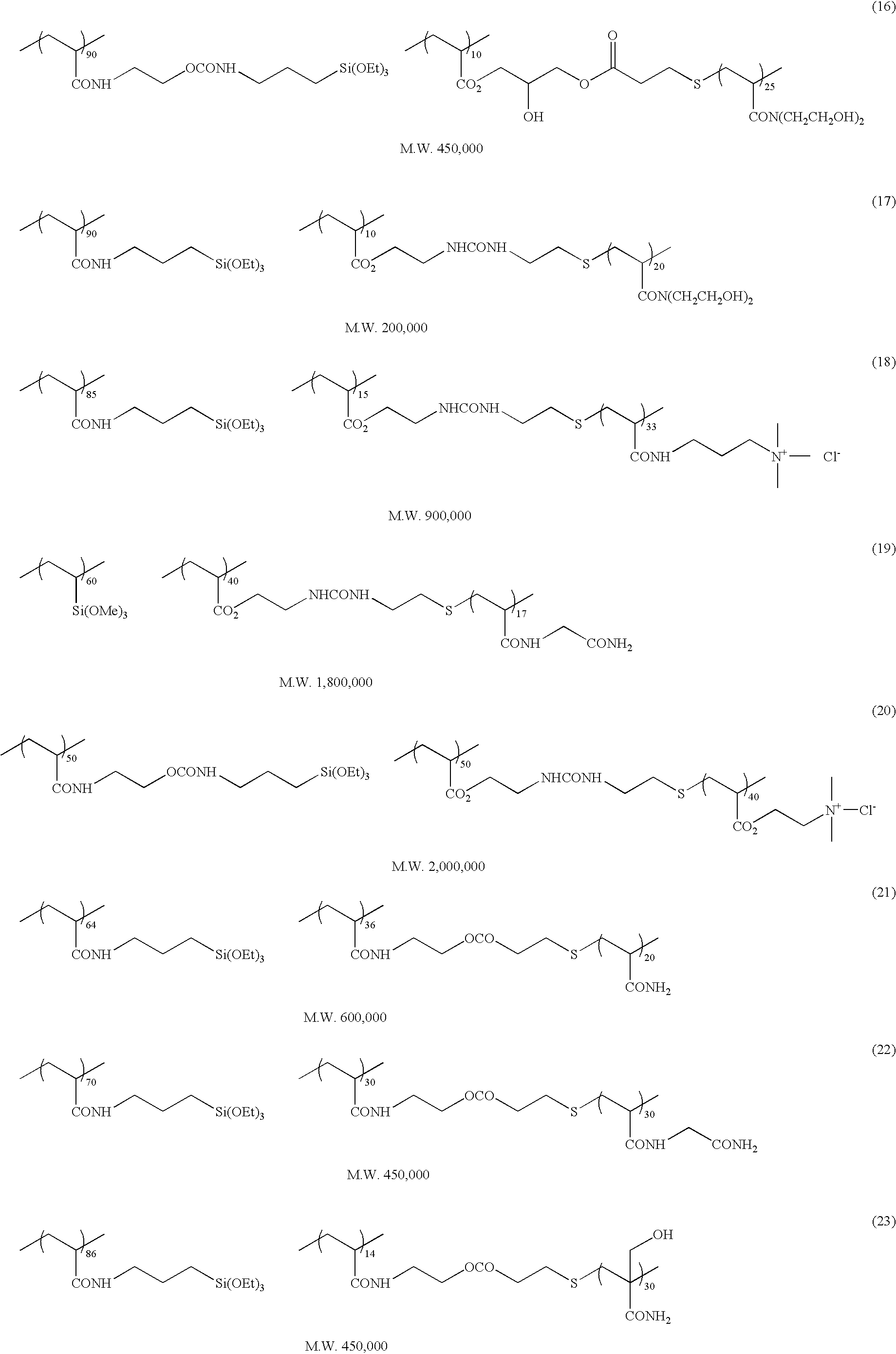

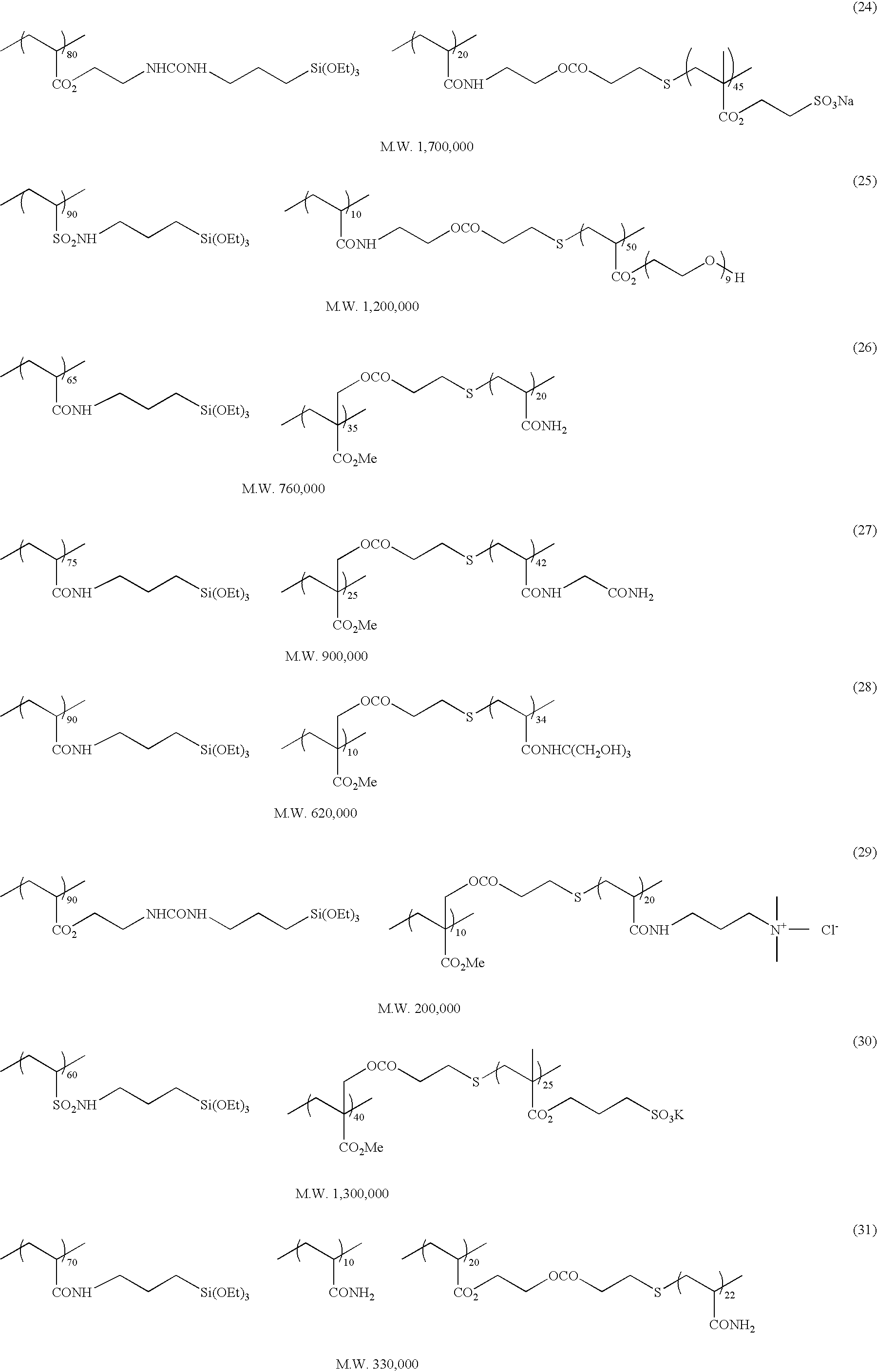

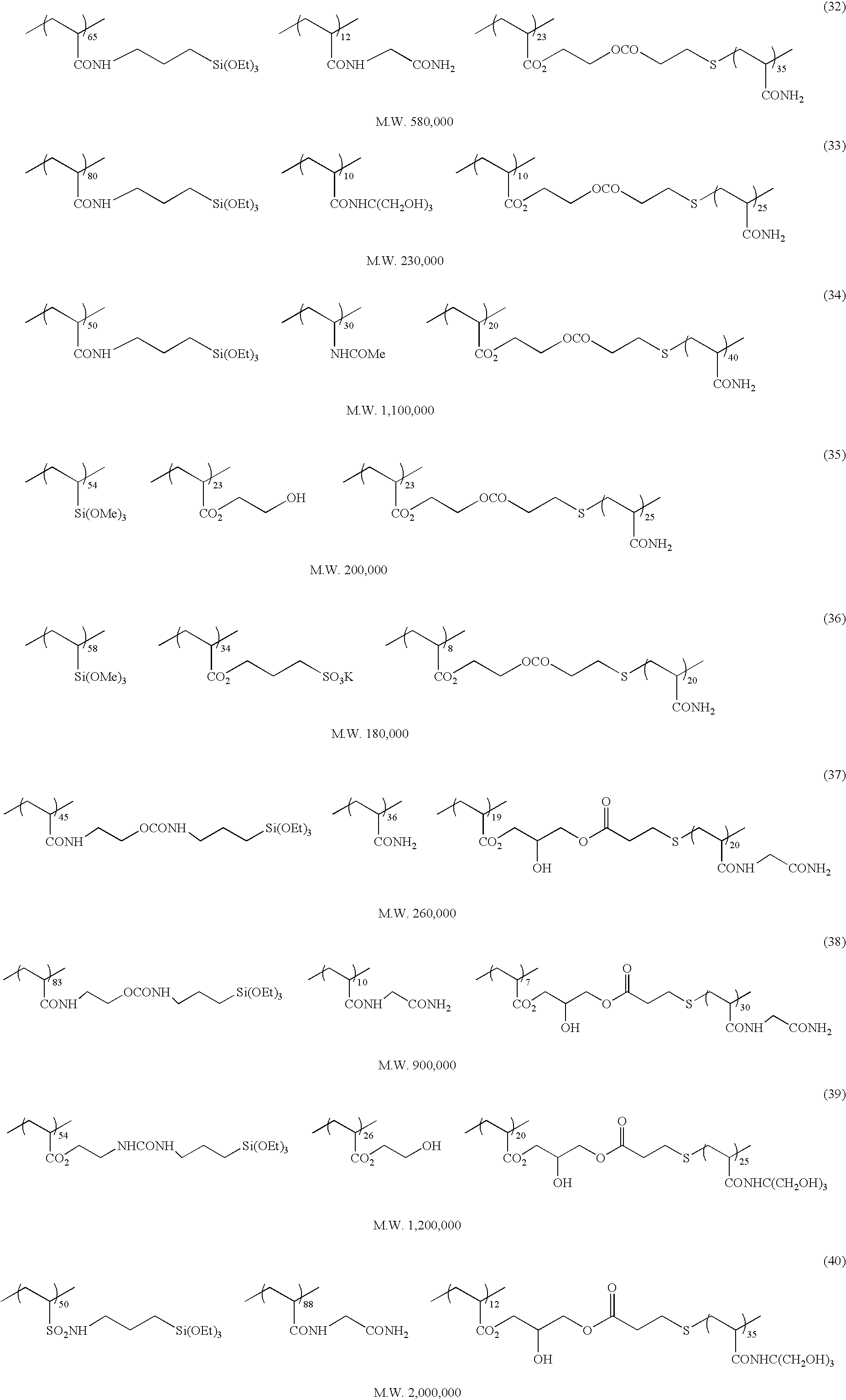

The polymer represented by formula (I) or (II) may also be a copolymer with other monomers. Examples of the other monomer used include known monomers such as acrylic acid esters, methacrylic acid esters, acrylamides, methacrylamides, vinyl esters, styrenes, acrylic acid, methacrylic acid, acrylonitrile, maleic anhydride and maleic acid imide. By copolymerizing such monomers, various properties such as film-forming property, film strength, hydrophilicity, hydrophobicity, solubility, reactivity and stability can be improved.

In the present invention, a hydrophilic polymer represented by the following formula (IV) is also preferred.

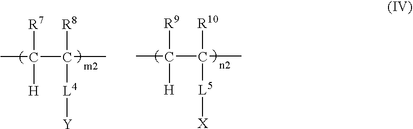

In formula (IV), R⁷, R⁸, R⁹ and R¹⁰ each independently represents a hydrogen atom or a hydrocarbon group and is specifically the same as R¹ and R² in formula (I). L⁴ and L⁵ each independently represents a single bond or a linking group and is specifically the same as L¹ in formula (I). Y and X have the same meanings as in formulae (I) and (II), and preferred ranges are also the same. m2 and n2 define the compositional ratio of respective structures when m2+n2=100, provided that m2≧30. In the present invention, L⁵ is preferably a single bond or a linking group having one or more structures selected from the group consisting of —CONH—, —NHCONH—, —OCONH—, —SO₂NH— and —SO₃—.

A side chain-type silane polymer represented by formula (IV) is most preferred, because a large number of hydrolyzable silyl groups can be introduced per one molecule and significantly good curability can be obtained by the drying at ordinary temperature.

Specific examples [Compounds (1) to (50)] of the polymer represented by formula (IV) are set forth below together with the mass average molecular weight (M.W.) thereof, but the present invention is not limited thereto. In specific examples below, the polymer is a random copolymer or a block copolymer where respective structural units shown are contained in the indicated molar ratio. The monomer structural unit on the side not having an Si group is the structural unit having a hydrophilic group of the present invention.

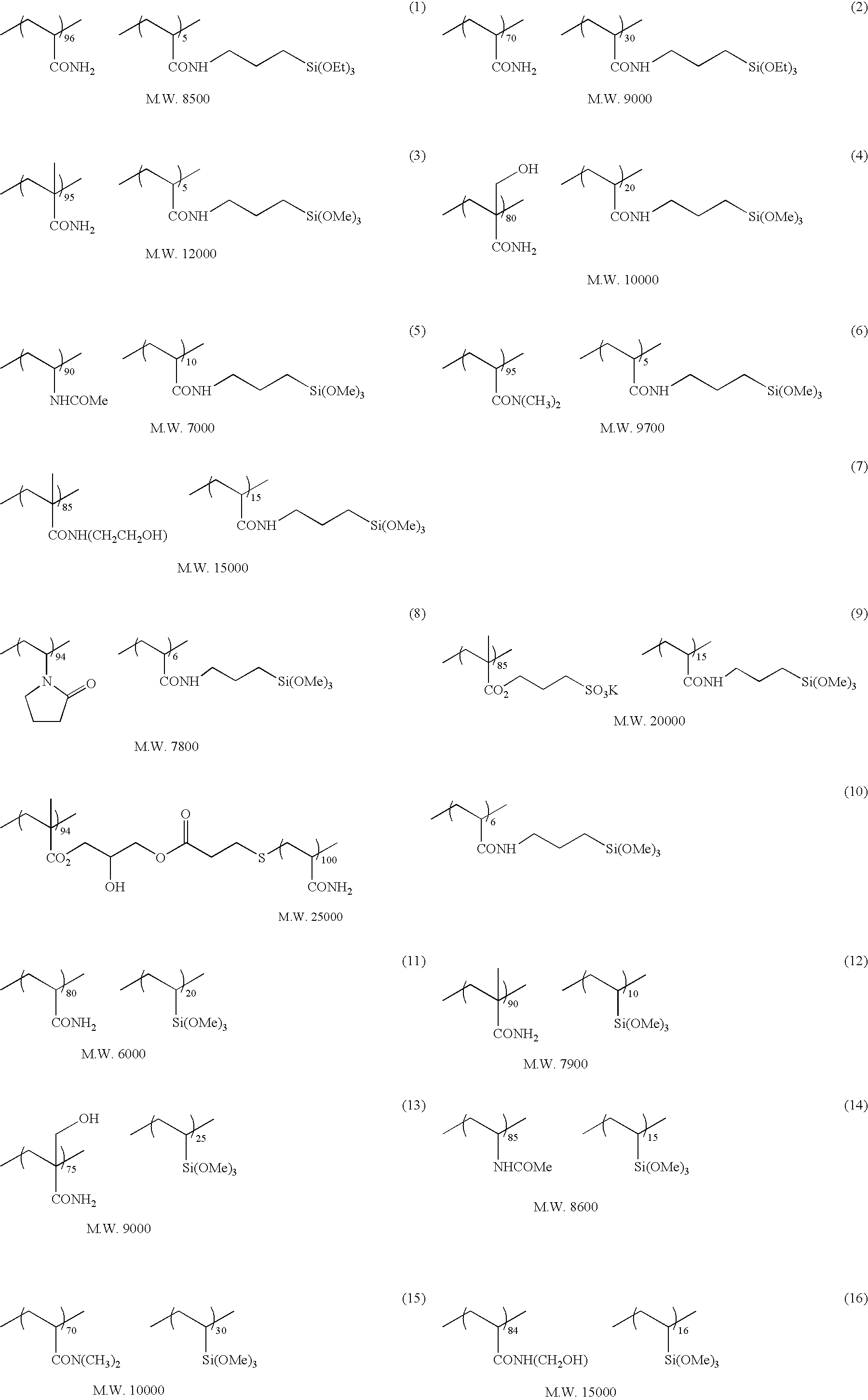

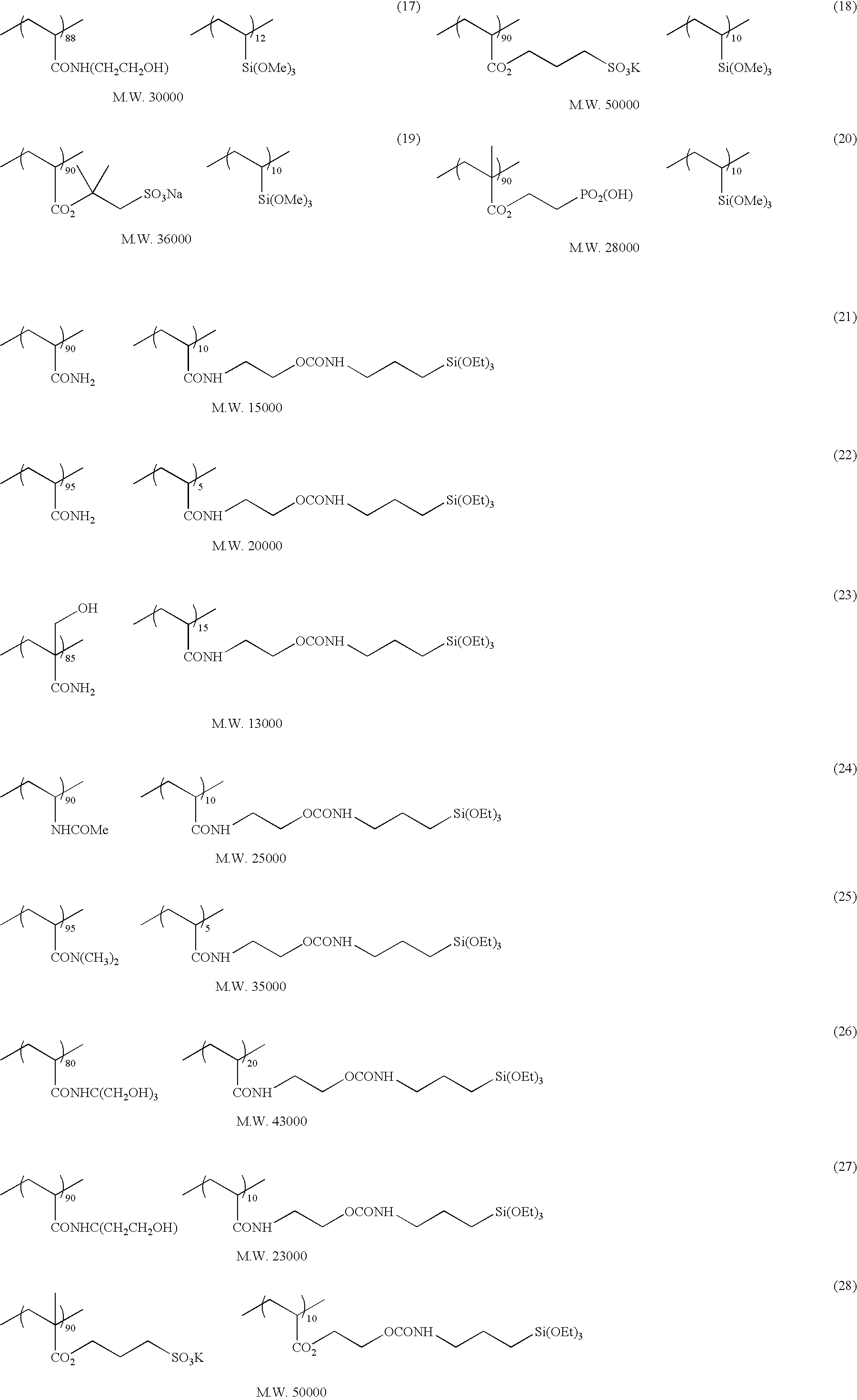

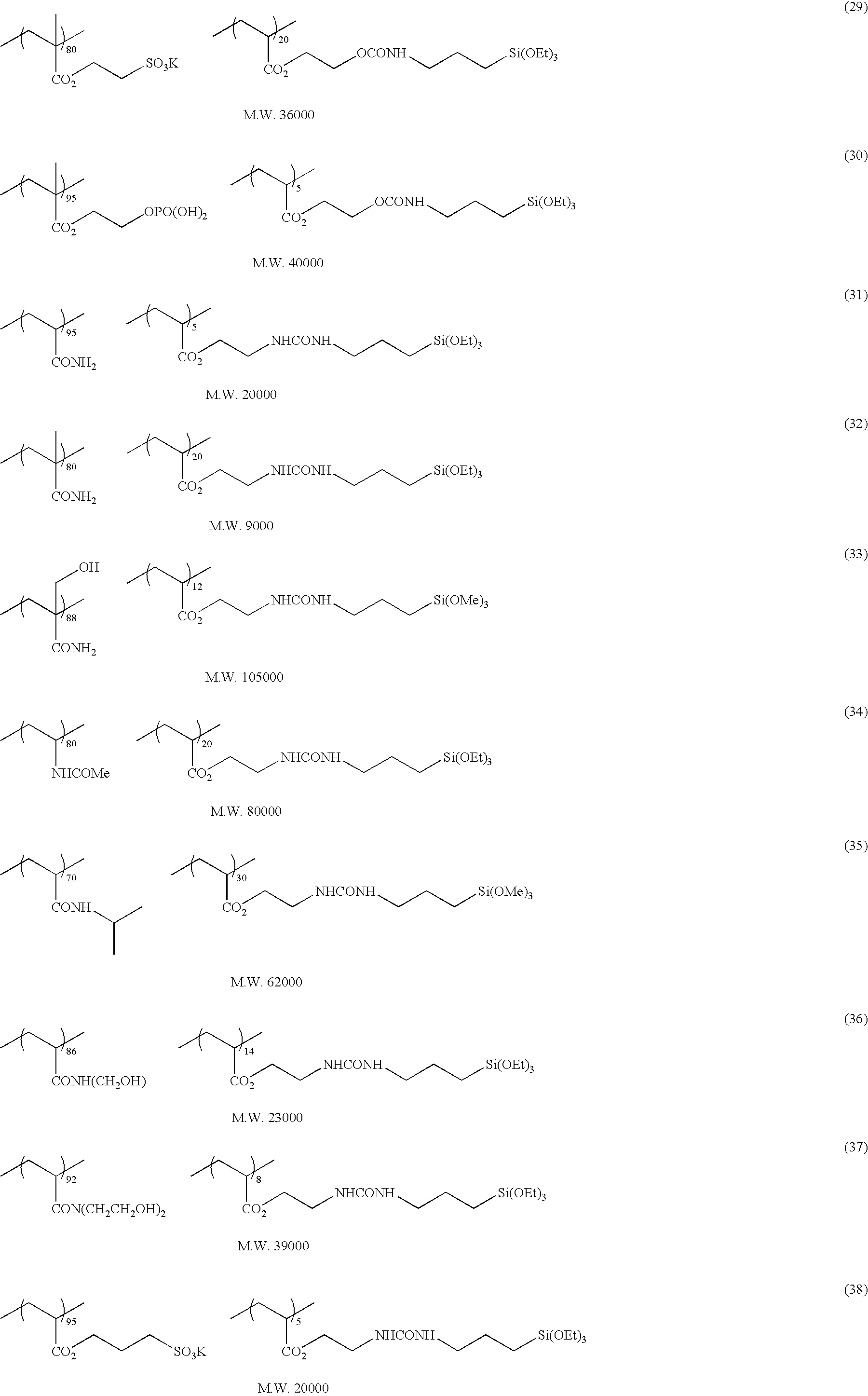

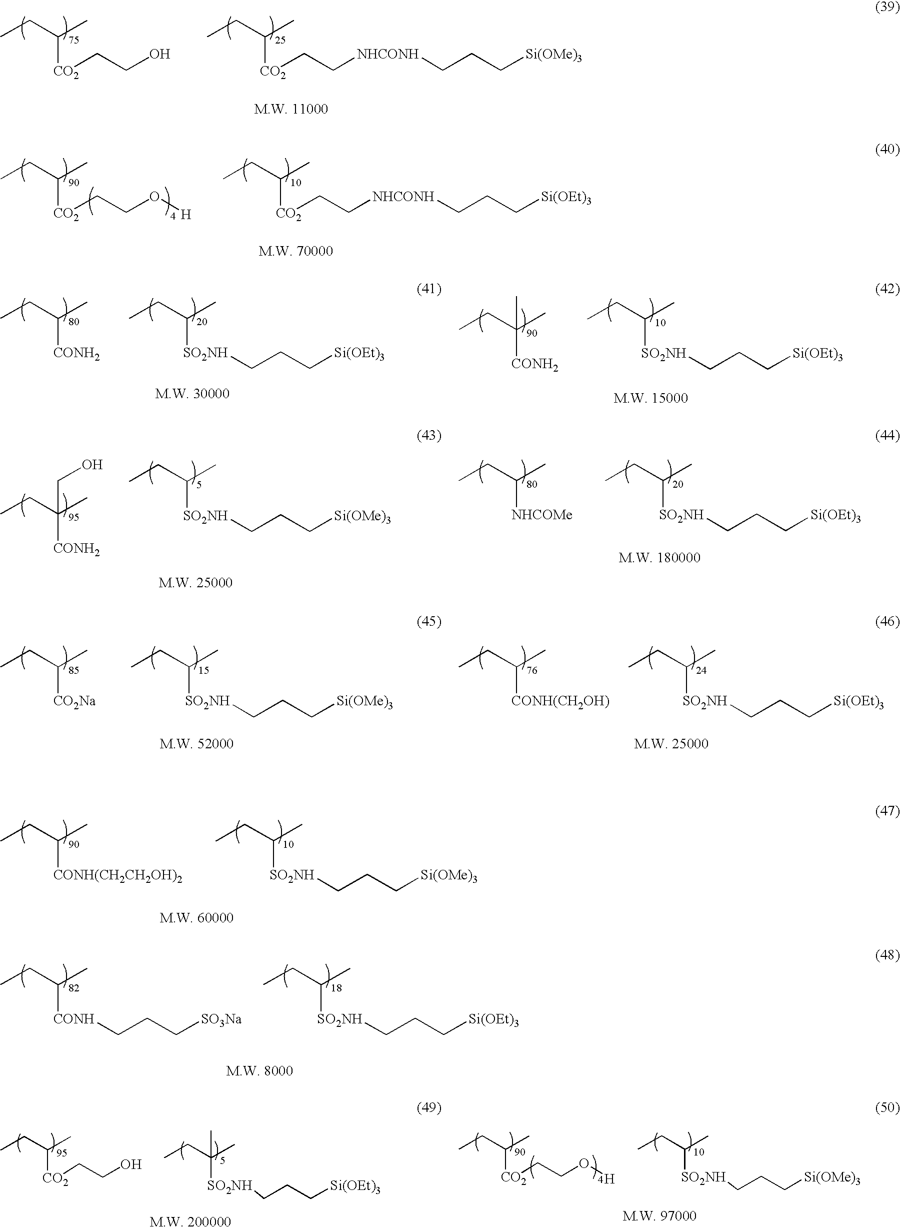

These compounds for synthesizing the polymer represented by formula (IV) are commercially available or can be easily synthesized.

As regards the radical polymerization method for synthesizing the polymer represented by formula (IV), any of conventionally known methods may be used. The general radical polymerization methods are specifically described, for example, in Shin Kobunshi Jikken Gaku 3, Kobunshi no Gousei to Hanno 1 (New Polymer Experimentation 3, Synthesis and Reaction of Polymers 1), compiled by Polymer Society Japan, Kyoritsu Shuppan, Shin Jikken Kagaku Koza 19, Kobunshi Kagaku (I) (Lecture on New Experimental Chemistry 19, Polymer Chemistry (I)), compiled by The Chemical Society of Japan, Maruzen, and Busshitsu Kogaku Koza, Kobunshi Gousei Kagaku (Lecture on Substance Engineering, Polymer Synthesis Chemistry), Publishing Division of Tokyo Denki University, and these can be applied.

The polymer represented by formula (IV) may also be a copolymer with other monomers. Examples of the other monomer used include known monomers such as acrylic acid esters, methacrylic acid esters, acrylamides, methacrylamides, vinyl esters, styrenes, acrylic acid, methacrylic acid, acrylonitrile, maleic anhydride and maleic acid imide. By copolymerizing such monomers, various properties such as film-forming property, film strength, hydrophilicity, hydrophobicity, solubility, reactivity and stability can be improved.

The mass average molecular weight of the polymer represented by formula (IV) is preferably from 1,000 to 1,000,000, more preferably from 1,000 to 500,000, and most preferably from 1,000 to 200,000.

A polymer represented by the following formula (V) is also preferred as the hydrophilic polymer for use in the present invention.

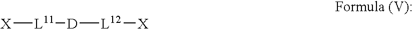

In formula (V), X has the same meaning as in formula (I), and specific examples and preferred ranges are also the same. L¹¹ and L¹² each independently represents a divalent linking group having three or more kinds of atoms selected from a carbon atom, a hydrogen atom, an oxygen atom, a nitrogen atom and a sulfur atom.

D represents a polymer or oligomer where structural units each independently forms a repeating structure.

L¹¹ and L¹² each independently represents a divalent linking group having three or more kinds of atoms selected from a carbon atom, a hydrogen atom, an oxygen atom, a nitrogen atom and a sulfur atom and is specifically a linking group composed of from 0 to 60 carbon atoms, from 0 to 10 nitrogen atoms, from 0 to 50 oxygen atoms, from 0 to 100 hydrogen atoms and from 0 to 20 sulfur atoms. That is, this linking group does not include a divalent linking group comprising only a carbon atom and a sulfur atom, such as unsubstituted alkylene group. More specific examples of the linking group include those composed solely of one of the following structural units excluding the structural units comprising only two kinds of atoms, and those composed of a plurality of the following structural units in combination.

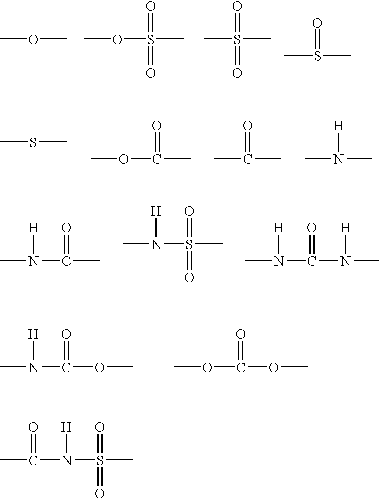

D represents a polymer or oligomer where a structural unit forms a repeating structure. That is, D may be a polymer where structural units each forms a repeating structure, or an oligomer where structural units form a repeating structure. Specifically, one or more structures selected from a polymer and an oligomer, which are contained in the polymer, are preferably polyacrylate, polymethacrylate, polyacrylonitrile, polyvinyl, polystyrene or the like each comprising an unsaturated double bond-based monomer. Other preferred examples include poly(oxyalkylene), polyurethane, polyurea, polyester, polyamide, polyimide, polycarbonate, and polyamino acid. Among these, poly(oxyalkylene), polyurethane, polyurea, polyester and polyamide are more preferred, and poly(oxyalkylene), polyurethane and polyurea are still more preferred.

The polymer or oligomer may be constituted by one kind or two or more kinds of these structural units.

The molecular weight of the polymer represented by formula (V) is preferably from 100 to 1,000,000, more preferably from 1,000 to 500,000, and most preferably from 1,000 to 200,000. The structure of the terminal alkoxysilyl group, the structure of the polymer or oligomer represented by D, the polymerization molar ratio and the polymerization degree may be selected to obtain a preferred molecular weight described above.

Specific preferred examples of the polymer represented by formula (V) which can be suitably used in the present invention are set forth below, but the present invention is not limited thereto. In each structure below, when D is a polymer having alkylene oxide in the main chain structure, the numerical values denoted for the constituent structural units indicate the polymerization molar ratio of respective structural units, and the numerical value denoted for the repeating unit in the side chain structure indicates the number of actually connected repeating units. In the case where D is polyurethane or polyurea, the terminal structure and the monomer structures are shown in the Table. That is, in polymers as specific examples, a terminal structure and a monomer structure are chemically bonded to form a urethane or urea bond, whereby a polymer is obtained. Also, the numerical values denoted for the monomer structures in the Table indicate the compositional ratio of monomers when a polymer is formed.

First, specific examples [Compounds (I-1) to (I-34)] of the polymer represented by formula (V) are set forth below together with the mass average molecular weight (M.W.) thereof. Incidentally, in some compounds, the Compound where the compositional ratio of monomers constituting the Compound is a molar ratio, is shown by a compound introduced into the terminal of a copolymer obtained by polymerizing the monomers, indicating that the Compound is composed of such a compound. When only one compound is shown as the compound introduced into the terminal, this indicates that the compound is introduced into both terminals.

| | | | | Mol % of Hydrophilic Group Structural Unit |
|---|---|---|---|---|
| (I-1) | 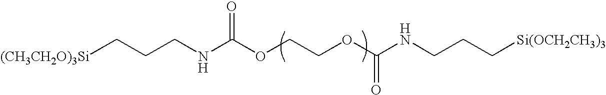 | M.W. | 4,000 | 98% |
| (I-2) | 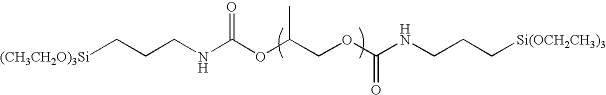 | M.W. | 4,000 | 97% |
| (I-3) | 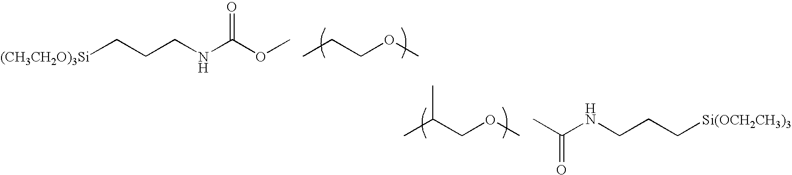 | M.W. | 20,000 | 99% |
| (I-4) | 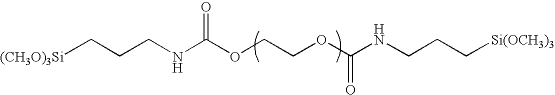 | M.W. | 500,000 | 99% |
| (I-5) | 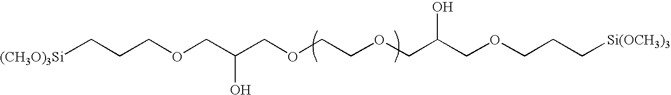 | M.W. | 1,500,000 | 99% |
| (I-6) | 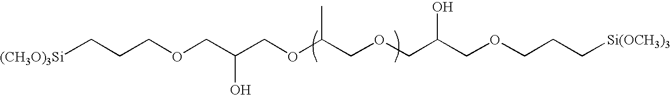 | M.W. | 6,000 | 99% |
| (I-7) | 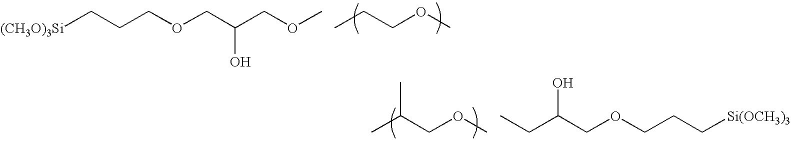 | M.W. | 10,000 | 98% |
| (I-8) | 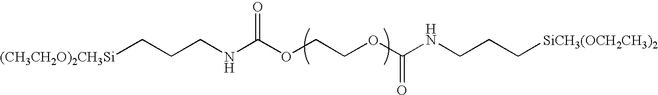 | M.W. | 8,000 | 98% |
| (I-9) | 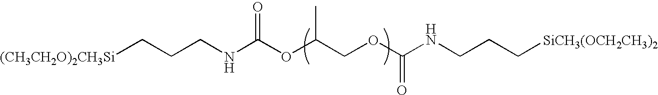 | M.W. | 50,000 | 99% |
| (I-10) | 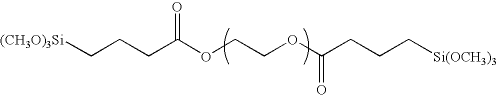 | M.W. | 2,000 | 95% |

| | | | | | Mol % of |
|---|---|---|---|---|---|
| | | | | | Hydrophilic |
| | | | | | Group Structural |
| | Terminal | Monomer (diisocyanate) | Monomer (diol) | *1 | Unit |
| (I-11) | 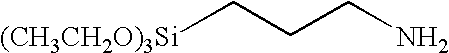 | 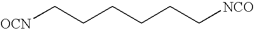 | 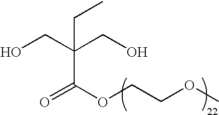 | 10,000 | 81% |
| (I-12) | 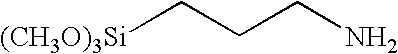 | 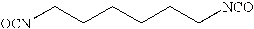 | 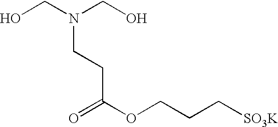 | 5,000 | 83% |
| (I-13) | 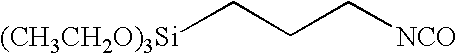 | 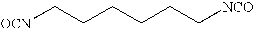 | 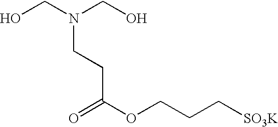 | 8,000 | 89% |
| (I-14) | 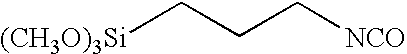 | 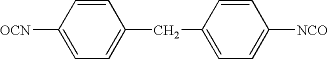 | 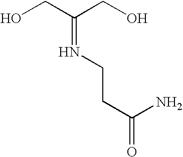 | 12,000 | 93% |
| (I-15) | 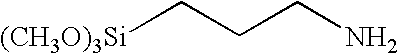 | 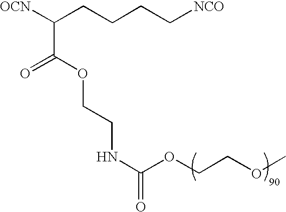 | 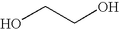 | 100,000 | 92% |
| (I-16) | 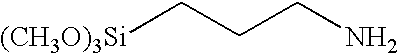 | 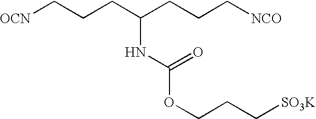 | 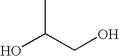 | 20,000 | 95% |
| (I-17) | 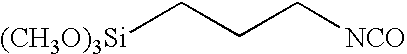 | 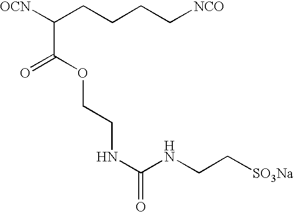 | 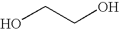 | 15,000 | 94% |
| (I-18) | 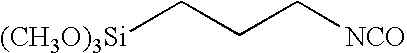 | 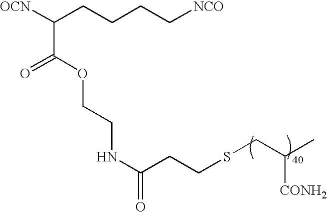 | 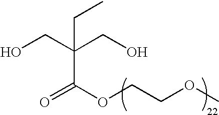 | 70,000 | 89% |
| (I-19) | 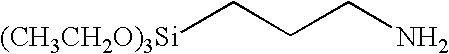 | 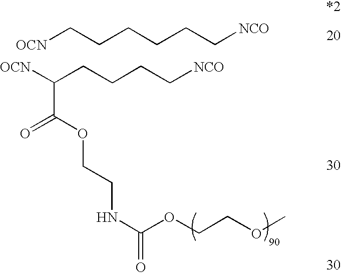 | 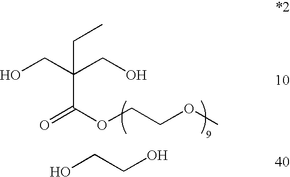 | 90,000 | 93% |
| (I-20) | 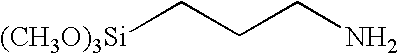 | 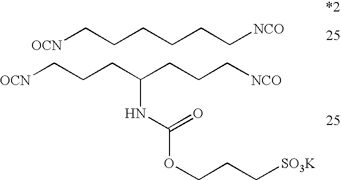 | 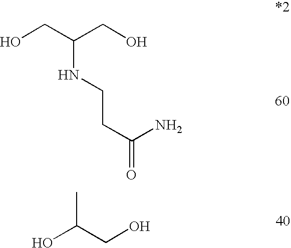 | 100,000 | 99% |
| (I-21) | 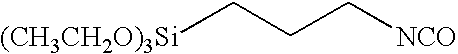 | 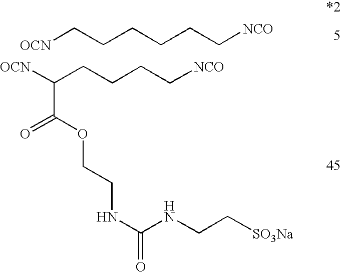 | 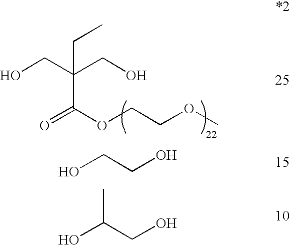 | 35,000 | 95% |
| (I-22) | 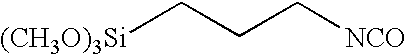 | 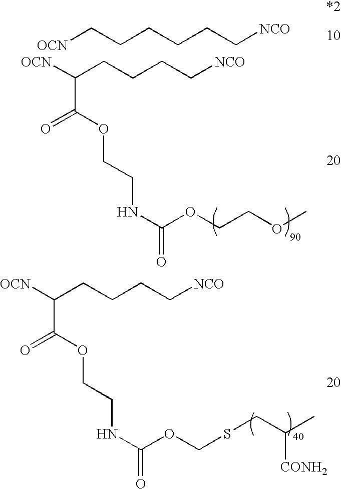 | 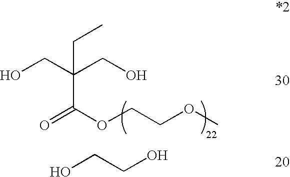 | 100,000 | 95% |
| (I-23) | 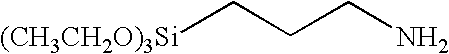 | 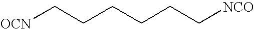 | 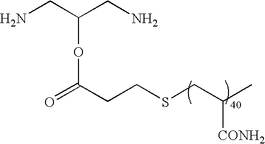 | 20,000 | 78% |
| (I-24) | 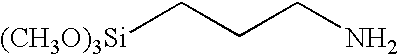 | 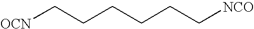 | 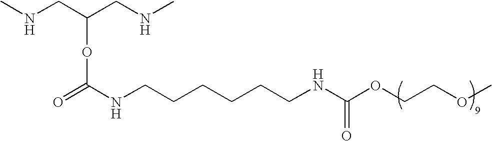 | 40,000 | 97% |
| (I-25) | 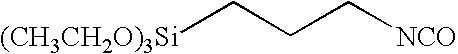 | 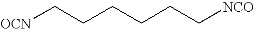 | 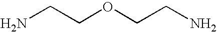 | 10,000 | 98% |
| (I-26) | 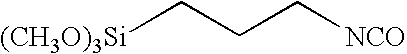 | 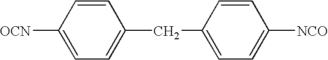 | 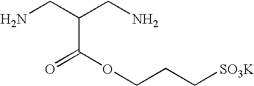 | 35,000 | 98% |
| (I-27) | 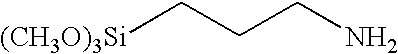 | 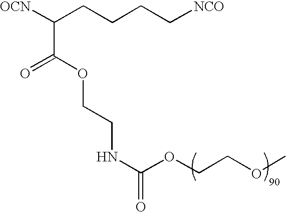 | 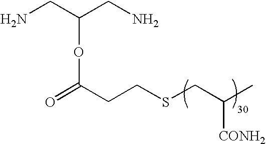 | 50,000 | 91% |
| (I-28) | 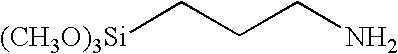 | 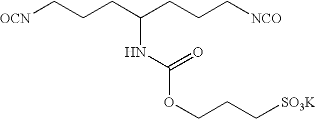 | 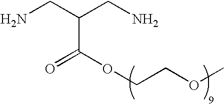 | 20,000 | 95% |
| (I-29) | 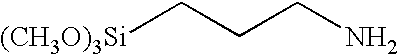 | 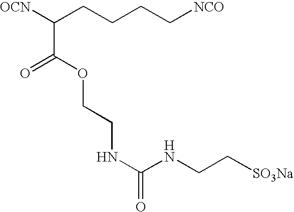 | 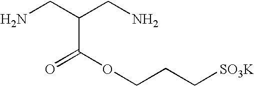 | 80,000 | 99% |
| (I-30) | 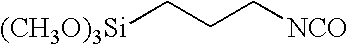 | 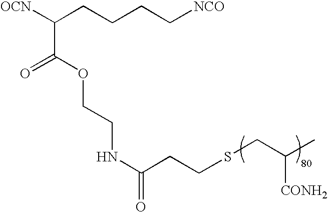 | 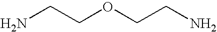 | 30,000 | 77% |
| (I-31) | 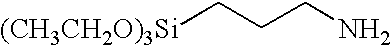 | 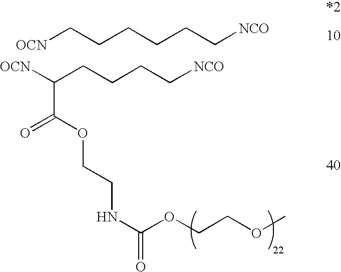 | 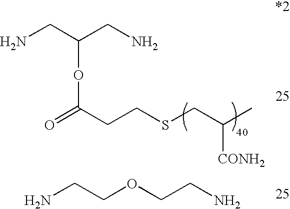 | 200,000 | 99% |
| (I-32) | 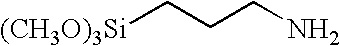 | 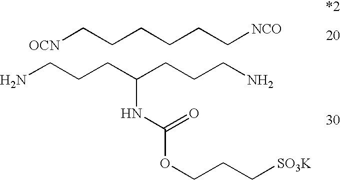 | 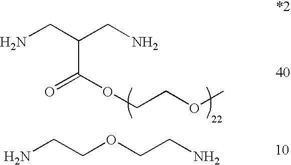 | 50,000 | 98% |
| (I-33) | 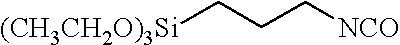 | 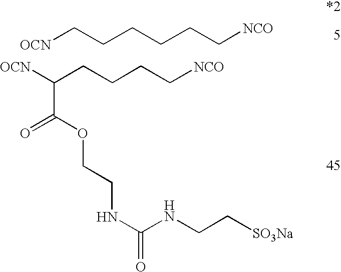 | 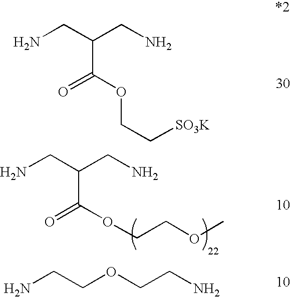 | 80,000 | 99% |
| (I-34) | 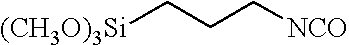 | 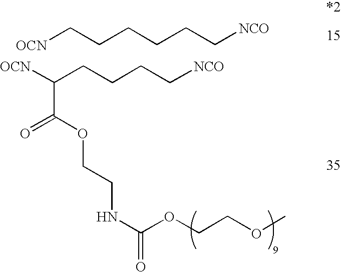 | 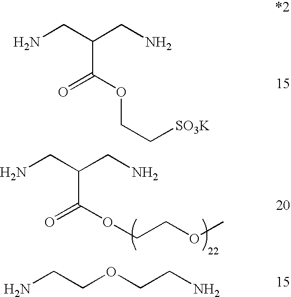 | 150,000 | 99% |

*1: Molecular Weight
*2: Compositional Ratio

This hydrophilic polymer forms a crosslinked film in the state of the polymer being mixed with a hydrolyzed polycondensate of a metal alkoxide. The hydrophilic polymer as an organic component participates in the strength or flexibility of the film and particularly, good film properties are obtained when the viscosity of the hydrophilic polymer is from 0.1 to 100 cPs (measured as an aqueous 5% solution at 25° C.), preferably from 0.5 to 70 cPs, more preferably from 1 to 50 cPs.

### [Crosslinking Agent]

The aqueous coating material composition of the present invention preferably contains a crosslinking agent. The crosslinking agent is preferably a metal alkoxide compound selected from Si, Ti, Zr and Al. The metal alkoxide for use in the present invention has in its structure a functional group capable of being hydrolyzed and polycondensed, and this is a hydrolysis-polymerizable compound fulfilling the function as a crosslinking agent, which forms a firm crosslinked film having a crosslinked structure resulting from polycondensation of metal alkoxides with each other and also forms a chemical bond with the hydrophilic polymer. The metal alkoxide can be represented by formula (VI-1) or (VI-2) and in the formulae, R⁸ represents a hydrogen atom, an alkyl group or an aryl group, R⁹ represents an alkyl group or an aryl group, Z represents Si, Ti or Zr, and m represents an integer of 0 to 2. When R⁸ and R⁹ represent an alkyl group, the carbon number of the alkyl group is preferably from 1 to 4. The alkyl group and aryl group each may have a substituent, and examples of the substituent which can be introduced include a halogen atom, an amino group and a mercapto group. Incidentally, these compounds are a low molecular compound and preferably have a molecular weight of 2,000 or less.

(R⁸)ₘ-Z-(OR⁹)₄₋ₘ (VI-1)

Al—(OR⁹)₃ (VI-2)

Specific examples of the hydrolyzable compounds represented by formulae (VI-1) and (VI-2) are described below, but the present invention is not limited thereto. Examples of the hydrolyzable compound where Z is Si, that is, the silicon-containing compound, include trimethoxysilane, tetramethoxysilane, tetraethoxysilane, tetrapropoxysilane, methyltrimethoxysilane, dimethyldimethoxysilane, γ-chloropropyltriethoxysilane, γ-mercaptopropyltrimethoxysilane, γ-aminopropyltriethoxysilane, phenyltrimethoxysilane and diphenyldimethoxysilane. Among these, preferred are trimethoxysilane, tetramethoxysilane, tetraethoxysilane, methyltrimethoxysilane, dimethyldimethoxysilane and phenyltrimethoxysilane.

Examples of the compound where Z is Ti, that is, the titanium-containing compound, include trimethoxytitanate, tetramethoxytitanate, triethoxytitanate, tetraethoxytitanate, tetrapropoxytitanate, chlorotrimethoxytitanate, chlorotriethoxytitanate, ethyltrimethoxytitanate, methyltriethoxytitanate, ethyltriethoxytitanate, diethyldiethoxytitanate, phenyltrimethoxytitanate and phenyltriethoxytitanate. Examples of the compound where Z is Zr, that is, the zirconium-containing compound, include zirconates corresponding to the above-described titanium-containing compounds.

Examples of the hydrolyzable compound where the center metal is Al, that is, the aluminum-containing compound, include trimethoxyaluminate, triethoxyaluminate, tripropoxyaluminate and triisopropoxyaluminate.

The metal alkoxide compound selected from Si, Ti, Zr and Al is preferably used in an amount of 1 to 80 mass %, more preferably from 5 to 70 mass %, based on the entire solid content of the aqueous coating material composition. (In this specification, mass ratio is equal to weight ratio.)

### [Curing Catalyst]

In the aqueous coating material composition of the present invention, when the hydrolyzable silyl group-containing hydrophilic polymer and further a crosslinking agent such as metal alkoxide compound are dissolved in a solvent and the solution is thoroughly stirred, these components undergo hydrolysis and polycondensation to form an organic-inorganic composite sol solution and by virtue of this sol solution, a hydrophilic film having high hydrophilicity and high strength is formed. In the preparation of the organic-inorganic composite sol solution, a curing catalyst is preferably used for accelerating the hydrolysis and polycondensation reactions.

The curing catalyst for use in the present invention is preferably an acidic catalyst, a based catalyst or a metal complex.

As regards the curing catalyst for use in the present invention, a catalyst capable of accelerating the reaction to hydrolyze and polycondense the crosslinking agent such as metal alkoxide compound and bring about bonding with the hydrolyzable silyl group-containing hydrophilic polymer is selected, and an acid or basic compound as it is or an acid or basic compound dissolved in water or a solvent such as alcohol (hereinafter these are sometimes collectively referred to as an acidic catalyst or a basic catalyst) is used. The concentration when dissolving an acid or basic compound in a solvent is not particularly limited and may be appropriately selected according to the properties of the acid or basic compound used, the desired catalyst content, and the like. Here, when the concentration of the acid or basic compound constituting the catalyst is high, the hydrolysis and polycondensation tend to proceed at a high rate. However, when a high-concentration basic catalyst is used, a precipitate may be produced in the sol solution. Therefore, in the case of using a basic catalyst, the concentration thereof is preferably 1N or less in terms of the concentration in an aqueous solution.

The kind of the acidic catalyst or basic catalyst is not particularly limited but when a high-concentration catalyst needs to be used, a catalyst composed of elements which scarcely remain in the coating film after drying is preferred. Specific examples of the acidic catalyst include a hydrogen halide such as hydrochloric acid, a carboxylic acid such as nitric acid, sulfuric, acid, sulfurous acid, hydrogen sulfide, perchloric acid, hydrogen peroxide, carbonic acid, formic acid and acetic acid, a substituted carboxylic acid where R in the structural formula RCOOH of the carboxylic acid is substituted by another element or a substituent, and a sulfonic acid such as benzenesulfonic acid. Specific examples of the basic catalyst include an ammoniacal base such as aqueous ammonia, and amines such as ethylamine and aniline.

In particular, the catalyst which can be used in the aqueous coating material composition of the present invention is preferably a metal complex.

The metal complex catalyst which can be used in the aqueous coating material composition of the present invention can accelerate the hydrolysis and polycondensation of the metal alkoxide compound selected from Si, Ti, Zr and Al and bring about bonding with the hydrophilic polymer. The metal complex is more preferably a metal complex of a metal element selected from Groups 2A, 3B, 4A and 5A of the Periodic Table with an oxo- or hydroxyoxygen-containing compound selected from a β-diketone, a ketoester, a hydroxycarboxylic acid or an ester thereof, an aminoalcohol and an enolic active hydrogen compound.

Among the constituent metal elements, preferred are a Group 2A element such as Mg, Ca, Sr and Ba, a Group 3B element such as Al and Ga, a Group 4A element such as Ti and Zr, and a Group 5A element such as V, Nb and Ta. These metal elements each forms a complex having an excellent catalyst effect. Above all, complexes formed from Zr, Al and Ti are excellent and preferred.

Examples of the oxo- or hydroxyoxygen-containing compound constituting the ligand of the metal complex for use in the present invention include β-diketones such as acetylacetone (2,4-pentanedione) and 2,4-heptanedione; ketoesters such as methyl acetoacetate, ethyl acetoacetate and butyl acetoacetate; hydroxycarboxylic acids and esters thereof, such as lactic acid, methyl lactate, salicylic acid, ethyl salicylate, phenyl salicylate, malic acid, tartaric acid and methyl tartrate; ketoalcohols such as 4-hydroxy-4-methyl-2-pentanone, 4-hydroxy-2-pentanone, 4-hydroxy-4-methyl-2-pentanone and 4-hydroxy-2-heptanone; aminoalcohols such as monoethanolamine, N,N-dimethylethanolamine, N-methyl-monoethanolamine, diethanolamine and triethanolamine; enolic active compounds such as methylolurea, methylolacrylamide and diethyl malonate; and compounds having a substituent on the methyl group, methylene group or carbonyl carbon of acetylacetone (2,4-pentanediol).

The ligand is preferably an acetylacetone or an acetylacetone derivative. The acetylacetone derivative indicates a compound having a substituent on the methyl group, methylene group or carbonyl carbon of acetylacetone. Examples of the substituent substituted on the methyl group of acetylacetone include a linear or branched alkyl group, an acyl group, a hydroxyalkyl group, a carboxyalkyl group, an alkoxy group, and an alkoxyalkyl group all having a carbon number of 1 to 3. Examples of the substituent substituted on the methylene group of acetylacetone include a carboxyl group, and a linear or branched carboxyalkyl group and a hydroxyalkyl group both having a carbon number of 1 to 3. Examples of the substituent substituted on the carbonyl carbon of acetylacetone include an alkyl group having a carbon number of 1 to 3, and in this case, a hydrogen atom is added to the carbonyl oxygen to form a hydroxyl group.

Specific preferred examples of the acetylacetone derivative include ethylcarbonylacetone, n-propylcarbonylacetone, i-propylcarbonylacetone, diacetylacetone, 1-acetyl-1-propionyl-acetyl acetone, hydroxyethylcarbonylacetone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone, and diacetone alcohol. Among these, acetylacetone and diacetylacetone are more preferred. The complex of an acetylacetone derivative with a metal element is a mononuclear complex in which from 1 to 4 acetylacetone derivative molecules are coordinated per one metal element, and in the case where the number of coordination bonds of the metal element is larger than the total number of coordination bonds of acetylacetone derivatives, the metal element may be coordinated with a ligand commonly used in a normal complex, such as water molecule, halogen ion, nitro group and ammonio group.

Preferred examples of the metal complex include a tris(acetylacetonato)aluminum complex salt, a di(acetylacetonato)aluminum.aquo-complex salt, a mono(acetylacetonato)aluninum.chloro-complex salt, a di(diacetyl-acetonato)aluminum complex salt, ethylacetoacetate aluminum diisopropylate, aluminum tris(ethylacetoacetate), a cyclic aluminum oxide isopropylate, a tris(acetylacetonato)barium complex salt a di(acetylacetonato)titanium complex salt, a tris(acetylacetonato)titanium complex salt, a di-i-propoxy.bis(acetylacetonato)titanium complex salt, a zirconium tris(ethylacetoacetate), and a zirconium tris(benzoate) complex salt. These metal complexes exhibit excellent stability in an aqueous coating solution and provide an excellent effect of accelerating the gelling in the sol-gel reaction at the drying under heat. Among these, ethylacetoacetate aluminum diisopropylate, aluminum tris(ethylacetoacetate), a di(acetylacetonato)titanium complex salt, and zirconium tris(ethylacetoacetate) are more preferred.

In the specification of the present invention, the counter salt of the metal complex is not described, but any kind of a counter salt may be used as long as it is a water-soluble salt capable of keeping the neutrality of the electric charge as a complex compound. For example, a salt form ensuring the stoichiometric neutrality, such as nitrate, halogen acid salt, sulfate and phosphate, is used. The behavior of the metal complex in the silica sol-gel reaction is described in detail in J. Sol-Gel, Sci. and Tec., 16, 209 (1999). As for the reaction mechanism, the following scheme is presumed. That is, in a coating liquid, the metal complex takes a coordination structure and is stable, whereas in a dehydrating condensation reaction that starts in the process of heating and drying after coating, the metal complex accelerates the crosslinking by an acid catalyst-like mechanism. Anyhow, by virtue of using the metal complex, the aging stability of the coating solution and the film surface quality are improved, and both high hydrophilicity and high durability are satisfied.

Other than the metal complex catalyst, a catalyst capable of accelerating the hydrolysis and polycondensation of the metal alkoxide compound selected from Si, Ti, Zr and Al and bringing about the bonding with the hydrophilic polymer may be used in combination. Examples of such a catalyst include a compound exhibiting acidity, such as hydrogen halide (e.g., hydrochloric acid), carboxylic acid (e.g., nitric acid, sulfuric acid, sulfurous acid, hydrogen sulfide, perchloric acid, hydrogen peroxide, carbonic acid, formic acid, acetic acid), substituted carboxylic acid where R in the structural formula RCOOH of the carboxylic acid is substituted by another element or a substituent, and sulfonic acid (e.g., benzenesulfonic acid); and a basic compound such as ammoniacal base (e.g., aqueous ammonia), and amines (e.g., ethylamine and aniline).

The above-described metal complex catalyst is easily available as a commercial product or may be obtained by a known synthesis method, for example, a reaction of each metal chloride with an alcohol.

The curing catalyst is preferably used in an amount of 0.1 to 20 mass %, more preferably from 1 to 10 mass %, based on the entire solid content of the aqueous coating material composition.

### [Particles]

It is preferred for the aqueous coating material composition of the present invention to contain particles. The particles of the present specification include an inorganic material, an organic material or an inorganic material and an organic material, and have a shape such as sphere, plate and rod. The particle diameter is not particularly limited, but the particles having a particle diameter of 10 nm to 10 μm are preferred in order to maintain the film quality of a coating film. By adding the particles, the effects of enhancing the hydrophilicity, preventing the film cracking or increasing the film strength are expected.

As specific kinds of the particles, for example, particles including an inorganic material such as inorganic pigment, silica, alumina, magnesium, titan and calcium, and particles including an organic material such as organic pigment, acryl, styrene, vinyl acetate, butadiene, chloroprene, ethylene, vinyl chloride and alkylene oxide are exemplified.

In addition, by subjecting the surface of the particles to a treatment with a coupling agent, etc., it is possible to improve the film quality and prevent the decrease in hydrophilicity.

When the contained amount of the particles is too much, the film quality of a coating film becomes week and the hydrophilicity decreases, thus the contained amount of the particles is preferably 80 mass % or less, more preferably 50 mass % or less, based on the entire solid content of the aqueous coating material composition.

The particles are easily available as a commercial product. Alternatively, it is possible to easily synthesize the particles including an inorganic material by grinding technique or sol-gel method etc. and the particles including an organic material by emulsion polymerization method, suspension polymerization method or phase inversion method etc.

### [Inorganic Fine Particle]

The aqueous coating material composition of the present invention may contain an inorganic fine particle for the purpose of enhancing the hydrophilicity, preventing the film cracking or increasing the film strength, Suitable examples of the inorganic fine particle include silica, alumina, magnesium oxide, titanium oxide, magnesium carbonate, calcium alginate, and a mixture thereof.

The inorganic fine particle preferably has an average particle diameter of 10 nm to 10 μm, more preferably from 0.5 to 3 m. Within this range, the particle is stably dispersed in the coating film and the strength of the coating film is satisfactorily maintained, so that a film with high durability and excellent hydrophilicity can be formed.

Out of the inorganic particles, a colloidal silica dispersion is preferred and this can be easily available as a commercial product.

The content of the inorganic fine particle is preferably 80 mass % or less, more preferably 50 mass % or less, based on the entire solid content of the aqueous coating material composition.

### [Other Components]

Various additives which can be used, if desired, in the aqueous coating material composition are described below.

### 1) Surfactant

In the aqueous coating material composition of the present invention, a surfactant may be added.

The surfactant includes those described in JP-A-62-173463 and JP-A-62-183457. Examples thereof include an anionic surfactant such as dialkylsulfosuccinates, alkylnaphthalenesulfonates and fatty acid salts; a nonionic surfactant such as polyoxyethylene alkyl ethers, polyoxyethylene alkyl allyl ethers, acetylene glycols, polyoxyethylene.polyoxypropylene block copolymers; and a cationic surfactant such as alkylamine salts and quaternary ammonium salts. Here, an organic fluoro compound may be used in place of the surfactant. The organic fluoro compound is preferably hydrophobic. The organic fluoro compound includes, for example, a fluorine-containing surfactant, an oily fluorine-based compound (e.g., fluorine oil), and a solid fluorine compound resin (e.g., ethylene tetrafluoride resin), and examples thereof include those described in JP-B-57-9053 (columns 8 to 17) and JP-A-62-135826.

### 2) Ultraviolet Absorbent

In the present invention, from the standpoint of enhancing the weather resistance and durability of the coating film, an ultraviolet absorbent can be used.

Examples of the ultraviolet absorbent include benzotriazole-based compounds described in JP-A-58-185677, JP-A-61-190537, JP-A-2-782, JP-A-5-197075 and JP-A-9-34057, benzophenone-based compounds described in JP-A-46-2784, JP-A-5-194483 and U.S. Pat. No. 3,214,463, cinnamic acid-based compounds described in JP-B-48-30492, JP-B-56-21141 and JP-A-10-88106, triazine-based compounds described in JP-A-4-298503, JP-A-8-53427, JP-A-8-239368, JP-A-10-182621 and JP-T-8-501291 (the term “JP-T” as used herein means a “published Japanese translation of a PCT patent application”), compounds described in Research Disclosure, No. 24239, and compounds capable of absorbing ultraviolet light and emitting fluorescent light, so-called fluorescent brightening agents, as typified by stilbene-based compounds and benzoxazole-based compounds.

The amount of the ultraviolet absorbent added is appropriately selected according to the purpose but in general, is preferably from 0.5 to 15 mass % in terms of the solid content.

### 3) Antioxidant

An antioxidant may be added for enhancing the stability of the aqueous coating material composition of the present invention. Examples of the antioxidant include those described in EP-A-223739, EP-A-309401, EP-A-309402, EP-A-310551, EP-A-310552, EP-A-459416, DE-A-3435443, JP-A-54-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

The amount of the antioxidant added is appropriately selected according to the purpose but is preferably from 0.1 to 8 mass % in terms of the solid content.

### 4) Solvent

For ensuring the formability of a uniform coating film on a substrate at the time of forming a coating film of the aqueous coating material composition of the present invention, it is also effective to appropriately add an organic solvent to the aqueous coating material composition.

Examples of the solvent include a ketone-based solvent such as acetone, methyl ethyl ketone and diethyl ketone, an alcohol-based solvent such as methanol, ethanol, 2-propanol, 1-propanol, 1-butanol and tert-butanol, a chlorine-based solvent such as chloroform and methylene chloride, an aromatic solvent such as benzene and toluene, an ester-based solvent such as ethyl acetate, butyl acetate and isopropyl acetate, an ether-based solvent such as diethyl ether, tetrahydrofuran and dioxane, and a glycol ether-based solvent such as ethylene glycol monomethyl ether and ethylene glycol dimethyl ether.

In this case, the solvent is preferably added in a range not causing a problem in relation to VOC (volatile organic compounds), and the amount thereof is preferably from 0 to 50 mass %, more preferably from 0 to 30 mass %, based on the entire aqueous coating material composition.

### 5) Polymer Compound

In the aqueous coating material composition of the present invention, various polymer compounds may be added for adjusting the physical properties of the coating film, within the range not inhibiting the hydrophilicity. Examples of the polymer compound which can be used include an acrylic polymer, a polyvinyl alcohol resin, a polyvinylbutyral resin, a polyurethane resin, a polyamide resin, a polyester resin, an epoxy resin, a phenol resin, a polycarbonate resin, a polyvinylformal resin, shellac, a vinyl-based resin, an acrylic resin, a rubber-based resin, waxes, and other natural resins. Two or more of these may be used. Above all, a vinyl-based copolymer obtained by the copolymerization of acrylic monomers is preferred. Furthermore, as to the copolymerization composition of a polymer binder, there may also be preferably used a copolymer where a “carboxyl group-containing monomer”, an “alkyl methacrylate” or an “alkyl acrylate” is contained as a structural unit.

### 6) Pigment

In the aqueous coating material composition of the present invention, a pigment can be blended. The pigment which can be used includes an inorganic pigment such as titanium oxide, zinc oxide, carbon black, aluminium powder type, ferric oxide (red iron oxide), lead chromate, molybdate orange, chrome yellow, ocher, ultramarine blue and cobalt green, and an organic pigment such as azo type, naphthol type, pyrazolone type, anthraquinone type, perylene type, quinacridone type, disazo type, isoindolinone type, benzimidazole type, phthalocyanine type and quinophthalone type. Also, an extender pigment such as heavy calcium carbonate, clay, kaolin, talc, precipitated barium sulfate, barium carbonate, white carbon and diatomaceous earth may be used. In particular, in the case of forming a matted coating film, use of white carbon or diatomaceous earth is most preferred because the effect of uncontaminating the coating film surface is least impaired. Incidentally, when such an inorganic material is added to the coating material, it is preferred to treat the powder surface with a coupling agent or add a coupling agent to the coating material.

The amount of the pigment added is not particularly limited but is preferably from 0.1 to 20% based on the entire solid content of the aqueous coating material composition. If the amount added is less than this range, the effect of the pigment can be hardly brought out, whereas if it exceeds the range above, there arises a problem such as decrease in the hydrophilicity or reduction of the film strength. The amount added is more preferably from 1 to 10%, because good results are obtained in all of the effect of pigment, hydrophilicity and film strength.

The particle diameter of the pigment is not particularly limited but, in view of film strength, is preferably from 0.01 to 100 μm, more preferably from 0.1 to 10 μm,

### 7) Dehydrating Agent and Alkyl Alcohol

In the aqueous coating material composition of the present invention, a dehydrating agent can be blended. Specific examples of the dehydrating agent include a hydrolyzable ester compound such as methyl orthoformate, ethyl orthoformate, methyl orthoacetate, ethyl orthoacetate, methyltrimethoxysilane, γ-methacryloxypropyltrimethoxysilane and vinyltrimethoxysilane.

In the aqueous coating material composition of the present invention, an alkyl alcohol can be blended. Examples of the alkyl alcohol include a low molecular weight alcohol such as methanol and ethanol.

At the polymerization of the hydrophilic polymer, the dehydrating agent and/or alkyl alcohol may be added before, after or during the polymerization. The amount of the dehydrating agent and/or alkyl alcohol used is not particularly limited but is preferably from 0.5 to 20 parts by mass, more preferably from 2 to 10 parts by mass, per 100 parts by mass of the solid content of the hydrophilic polymer. Incidentally, when a dehydrating agent and an alkyl alcohol are used in combination, a remarkable effect is obtained on the storage stability and this is preferred.

### 8) Antifreezing Agent

By adding an antifreezing agent to the aqueous coating material composition of the present invention, even when used in a low-temperature environment where freezing occurs, the precipitation or separation of the pigment or the like can be suppressed and the quality of the composition as well as the handleability at the coating can be enhanced. Preferred examples of the antifreezing agent for use in the present invention include the followings.

(1) Monosaccharides, polysaccharides and their derivatives. Examples thereof include glucose, sucrose, maltose, trehalose, sorbitol, mannitol, mannose, fructose, ribose, xylose, arabinose, galactose, aldonic acid, cellobiose, lactose, maltotriose, and reducing sugars, oxides, dehydrated sugar derivatives, amino sugars and thiosugars of these saccharides. Among these, glucose, arabinose and galactose are preferred.

(2) Glycerin or alkylene glycols. Examples thereof include glycerin, ethylene glycol, diethylene glycol, triethylene glycol, propylene glycol, dipropylene glycol, 1,2-hexanediol, 1,6-hexanediol, 1,5-pentanediol and 1,4-butanediol. Among these, glycerin and ethylene glycol are preferred.

(3) Amino acid and its derivatives. Examples thereof include histidine, arginine, lysine, glycine, L-alanine, DL-alanine, L-isoleucine, L-valine, L-leucine, L-serine, L-threonine, L-cysteine, L-cystine, L-phenylalanine, L-proline, L-tyrosine, L-homoserine, L-methionine, L-methionine, DL-methionine, ε-aminocaproic acid, γ-aminobutyric acid, DL-threonine, aspartic acid and glutamic acid. Among these, glycine, L-alanine, DL-alanine and arginine are preferred.

(4) Urea and its derivatives. Examples thereof include urea, thiourea, ethyleneurea, N-methylurea, N,N-dimethylurea, N-ethylurea and N-hydroxyethylurea. Among these, urea, thiourea and ethyleneurea are preferred.

(5) Cyclic amide group-containing compound. Examples thereof include 2-pyrrolidone, N-methyl-2-pyrrolidone, ε-caprolactam, γ-caprolactam, N-hydroxyethyl-2-pyrrolidone and N-ethyl-2-pyrrolidone. Among these, 2-pyrrolidone and N-methyl-2-pyrrolidone are preferred.

Two or more of these antifreezing agents may be used as a mixture, if desired.

The amount of the antifreezing agent added to the aqueous coating material composition is preferably from 0.1 to 20 mass %, more preferably from 0.5 to 15 mass %, still more preferably from 1.0 to 10 mass %, based on the entire solid content of the aqueous coating material composition.

In addition to these components, the aqueous coating material composition of the present invention may contain components usable in a normal coating material. Examples of the component which can be used include a dye, an aggregate, a thickener, a film-forming aid, a leveling agent, a wetting agent, a plasticizer, an antifreezing agent, a pH adjusting agent, an antiseptic, an antifungal, an antialgal agent, a dispersant, a defoaming agent, an anti-rust agent, and a crosslinking agent other than that described above.

Furthermore, according to use, an additive such as diluting agent, light stabilizer, precipitation inhibitor and leveling agent, a cellulose such as nitrocellulose and cellulose acetate butyrate, a filler and the like may added without any problem, and known additives for coating material can be used.

In addition, for example, a leveling additive, a matting agent, waxes for adjusting the film properties, and a tackifier for improving the adhesive property to a substrate may be incorporated, if desired, in the range not inhibiting the hydrophilicity.

Specific examples of the tackifier include adhesive polymers having a high molecular weight described in JP-A-2001-49200, pages 5 and 6 (for example, a copolymerization product comprising an ester of (meth)acrylic acid and an alcohol containing an alkyl group having a carbon number of 1 to 20, an ester of (meth)acrylic acid and an alicyclic alcohol having a carbon number of 3 to 14, and an ester of (meth)acrylic acid and an aromatic alcohol having a carbon number of 6 to 14), and a low molecular weight tackifying resin having a polymerizable unsaturated bond.

### [Substrate]

The aqueous coating material composition of the present invention is coated on a substrate to form a coating film (hydrophilic layer), whereby a hydrophilic member can be obtained. The substrate for use in the present invention is not particularly limited, but glass, plastic, metal, ceramic, wood, stone, cement, concrete, fiber, cloth, paper, leather, and a combination or laminate thereof all may be suitably utilized. In particular, the substrate is preferably a glass substrate or a plastic substrate.

As for the glass substrate, any glass such as soda glass, lead glass and borosilicate glass may be used. Also, according to the purpose, float sheet glass, figured glass, frosted sheet glass, mesh glass, wired glass, tempered glass, laminated glass, double glass, vacuum glass, security glass, or highly insulating low-E double glass may be used. Furthermore, the hydrophilic layer may be provided directly on the green sheet glass, but one surface or both surfaces of the glass substrate may be subjected to a surface hydrophilizing treatment by oxidation, surface roughening or the like, for the purpose of enhancing the adhesive property of the hydrophilic layer. Examples of the oxidation method include a corona discharge treatment, a glow discharge treatment, a chromic acid treatment (wet), a flame treatment, a hot air treatment, and an ozone/ultraviolet irradiation treatment. As for the surface roughening method, the surface may also be mechanically roughened by sandblasting, brush polishing or the like.

The plastic substrate for use in the present invention is not particularly limited, but there may be used a film or sheet formed of polyester, polyethylene, polypropylene, cellophane, triacetyl cellulose, diacetyl cellulose, acetyl cellulose butyrate, polyvinyl chloride, polyvinylidene chloride, polyvinyl alcohol, polyethylene vinyl alcohol, polystyrene, polycarbonate, polymethylpentene, polysulfone, polyether ketone, acryl, nylon, fluororesin, polyimide, polyetherimide, or polyethersulfone. Above all, a polyester film such as polyethylene terephthalate or polyethylene naphthalate is preferred. Incidentally, a plastic substrate with excellent transparency is preferred from an optical viewpoint, but a translucent or printed substrate is used depending on the usage. The thickness of the plastic substrate varies according to the other party stacked thereon. For example, in use for a portion having many curves, a thin substrate is preferred and a plastic substrate having a thickness of approximately from 6 to 50 μm is used. Also, in use for a flat plane or a portion requiring strength, a plastic substrate of 50 to 400 μm is used.

For the purpose of enhancing the adhesive property between the substrate and the hydrophilic layer, one surface or both surfaces of the substrate may be subjected to a surface hydrophilizing treatment by oxidation, surface roughening or the like. Examples of the oxidation method include a corona discharge treatment, a glow discharge treatment, a chromic acid treatment (wet), a flame treatment, a hot air treatment, and an ozone/ultraviolet irradiation treatment. As for the surface roughening method, the surface may also be mechanically roughened by sandblasting, brush polishing or the like.

Furthermore, one or more undercoat layers can be provided. As for the material of the undercoat layer, a hydrophilic resin or a water-dispersible latex may be used.

Examples of the hydrophilic resin include polyvinyl alcohol (PVA), a cellulose-based resin [e.g., methyl cellulose, (MC), hydroxyethyl cellulose (HEC), carboxymethyl cellulose (CMC)], chitins, chitosans, starch, an ether bond-containing resin [e.g., polyethylene oxide (PEO), polyethylene glycol (PEG), polyvinyl ether (PVE)], and a carbamoyl group-containing resin [e.g., polyacrylamide (PAAM), polyvinylpyrrolidone (PVP)]. Other examples include a carboxyl group-containing polyacrylate, a maleic acid resin, an alginate, and gelatins.

Furthermore, a hydrolyzed condensate or the like of a metal alkoxide as typified, for example, by polysiloxane is also preferred, and the compounds described above as the crosslinking agent may be used.

Among these resins, at least one member selected from a polyvinyl alcohol-based resin, a cellulose-based resin, an ether bond-containing resin, a carbamoyl group-containing resin, a carboxyl group-containing resin, gelatins, and a hydrolyzed condensate of metal alkoxide is preferred, and a polyvinyl alcohol (PVA)-based resin, gelatins, and a hydrolyzed condensate of metal alkoxide are more preferred.

Examples of the water-dispersible latex include an acryl-based latex, a polyester-based latex, an NBR resin, a polyurethane-based latex, a polyvinyl acetate-based latex, an SBR resin, and a polyamide-based latex. Among these, an acryl-based latex is preferred.

One of these hydrophilic resins or water-dispersible latexes may be used alone or two or more thereof may be used in combination, and a hydrophilic resin and a water-dispersible latex may also be used in combination.

Also, a crosslinking agent capable of crosslinking the hydrophilic resin or water-dispersible latex may be used.

As for the crosslinking agent applicable to the present invention, known crosslinking agents which form the crosslinking under heat may be used. Thermal crosslinking agents in general are described in Shinzo Yamashita and Tosuke Kaneko, Kakyozai Handbook (Crosslinking Agent Handbook), Taseisha (1981). The crosslinking agent for use in the present invention is not particularly limited as long as the number of functional groups is 2 or more and it can be effectively crosslinked with the hydrophilic resin or water-dispersible latex. Specific examples of the thermal crosslinking agent include a polycarboxylic acid such as polyacrylic acid; an amine compound such as polyethyleneimine; a polyepoxy compound such as ethylene or propylene glycol diglycidyl ether, tetraethylene glycol diglycidyl ether, nonaethylene glycol diglycidyl ether, polyethylene or polypropylene glycol glycidyl ether, neopentyl glycol diglycidyl ether, 1,6-hexanediol diglycidyl ether, trimethylolpropane triglycidyl ether, and sorbitol polyglycidyl ether; a polyaldehyde compound such as glyoxal and terephthalaldehyde; a polyisocyanate compound such as tolylene diisocyanate, hexamethylene diisocyanate, diphenylmethane isocyanate, xylylene diisocyanate, polymethylene polyphenyl isocyanate, cyclohexyl diisocyanate, cyclohexane phenylene diisocyanate, naphtalene-1,5-diisocyanate, isopropylbenzene-2,4-diisocyanate, and polypropylene glycol/tolylene diisocyanate addition reaction product; a block polyisocyanate compound; a silane coupling agent such as tetraalkoxysilane; a metal crosslinking agent such as acetylacetonate of aluminum, copper or iron (III); and a polymethylol compound such as trimethylolmelamine and pentaerythritol. Out of these thermal crosslinking agents, a water-soluble crosslinking agent is preferred because a coating solution can be easily prepared and the reduction in the hydrophilicity of the produced hydrophilic layer can be prevented.

The total amount of the hydrophilic resin and/or water-dispersible latex in the undercoat layer is preferably from 0.01 to 20 g/m², more preferably from 0.1 to 10 g/m².

### [Layer Construction in Use of Hydrophilic Member]

In the case of using the hydrophilic member with expectation to bring out the antifouling and/or antifogging effects, separate layers may be appropriately added according to the purpose, mode and place in use. The construction of layers added, if desired, is described below.

### 1) Adhesive Layer

In the case of using the hydrophilic member by laminating it to another substrate, an adhesive which is a pressure-sensitive adhesive is preferably used as an adhesive layer on the back surface of the substrate. As for the adhesive, those generally used for a self-adhesive sheet, such as rubber-based adhesive, acryl-based adhesive, silicone-based adhesive, vinyl ether-based adhesive and styrene-based adhesive, may be used.

In the case where the optical transparency is required, an adhesive for optical usage is selected. In the case where a pattern such as coloration, translucence or mat texture is required, in addition to the texturing of the substrate, a dye or an organic or inorganic fine particle may be added to the adhesive to bring out the effect.

In the case where a tackifier is required, one kind of a resin, for example, a tackifying resin such as rosin-based resin, terpene-based resin, petroleum-based resin, styrene-based resin, and hydrogenation product thereof, may be used, or some of these may be used as a mixture.

The adhesive force of the adhesive for use in the present invention is an adhesive force generally called strong adhesion and is 200 g/25 mm or more, preferably 300 g/25 mm or more, more preferably 400 g/25 mm or more. The adhesive force as used herein is a value measured by a 180° peeling test according to JIS Z 0237.

### 2) Release Layer

In the case where the hydrophilic member has the above-described adhesive layer, a release layer may be further added. In the release layer, a release agent is preferably incorporated so as to impart releasability. Examples of the release agent which can be generally used include a silicone-based release agent comprising poly-organosiloxane and further include a fluorine-based compound, a long chain alkyl-modified polyvinyl alcohol, and a long chain alkyl-modified polyethyleneimine. Also, there may be used various release agents such as hot-melt release agent and monomer-type release agent capable of curing a releasing monomer through radical polymerization, cationic polymerization, polycondensation reaction or the like; a copolymer-based resin such as acryl-silicone-based copolymer resin, acryl-fluorine-based copolymer resin and urethane-silicone-fluorine-based copolymer resin; a resin blend of silicone-based resin and acryl-based resin; and a resin blend of fluorine-based resin and acryl-based resin. Furthermore, a hardcoat release layer may be formed by curing a curable composition containing either one atom of fluorine atom and/or silicon atom and an active energy ray-polymerizable group-containing compound.

### 3) Other Layers

A protective layer may be provided on the hydrophilic layer. The protective layer has a function of preventing scratching on the hydrophilic surface during handling, transportation or storage or preventing reduction in the hydrophilicity due to adhesion of a contaminant. The protective layer is stripped off after laminating the hydrophilic member to an appropriate substrate.

### [Form of Structure]

The structure having the hydrophilic layer may be supplied in the form of a sheet, roll or ribbon or may be cut into a size suitable for the lamination to an appropriate substrate and then supplied.

### [Surface Free Energy]

The hydrophilicity is generally measured as the contact angle for a water drop. However, the water drop contact angle on the surface having extremely high hydrophilicity as in the present invention sometimes becomes 10° or less, even 5 or less, and therefore, the cross comparison of the hydrophilicity degree has a limitation. On the other hand, measurement of surface free energy is known as a method for more particularly evaluating the hydrophilicity degree of a solid surface. Various methods have been proposed thereon, but in the present invention, the surface free energy is measured, for example, by a Zisman plotting method. More specifically, this is a method utilizing a property that the surface tension of an aqueous solution of an inorganic electrolyte such as magnesium chloride becomes larger with an increase in the concentration, where the contact angle is measured using the aqueous solution in air under the room temperature condition, points of the aqueous solution in various concentrations are plotted by taking the surface tension of the aqueous solution on the abscissa and the contact angle in terms of cos θ on the ordinate to obtain a linear relationship, and the surface tension giving cos θ=1, that is, contact angle=0°, is defined as the surface free energy of the solid. The surface tension of water is 72 mN/m, and as the value of surface free energy is larger, the hydrophilicity can be said to be higher.

A hydrophilic layer where the surface free energy as measured by the above-described method is from 70 to 95 mN/m, preferably from 72 to 93 mN/m, more preferably from 75 to 90 mN/m, is excellent in the hydrophilicity and exhibits good performance.

In the case of applying (using or laminating) the hydrophilic member having provided therein the hydrophilic layer to windowpane or the like, transparency is important from the standpoint of securing visibility. The above-described hydrophilic layer has excellent transparency, and the transparency is not impaired even when the thickness is large, so that both transparency and durability can be satisfied. The thickness of the hydrophilic layer is preferably from 0.01 to 100 μm, more preferably from 0.05 to 50 μm, and most preferably from 0.1 to 20 μm. When the thickness is 0.01 μm or more, sufficiently high hydrophilicity and durability are advantageously obtained, and when the thickness is 100 μm or less, a problem in the film-forming property, such as cracking, does not arise and this is preferred.

The transparency is evaluated by measuring the light transmittance in the visible light region (400 to 800 nm) by a spectrophotometer. The light transmittance is preferably from 100 to 70%, more preferably from 95 to 75%, and most preferably from 95 to 80%. By virtue of light transmittance in is range, the hydrophilic member having provided therein the hydrophilic layer can be applied to various uses without hindering the visibility.

The hydroplilic member can be obtained by coating the aqueous coating material composition of the present invention on an appropriate substrate and drying under heat the composition to form a surface hydrophilic layer. The heating temperature and heating time for the formation of the hydrophilic layer are not particularly limited as long as these are a temperature and a time where the solvent in the sol solution is removed and a strong film can be formed, but in view of production suitability and the like, the heating temperature is preferably 150° C. or less, and the heating time is preferably 1 hour or less.

The hydrophilic member can be produced by a known coating method, and the coating method is not particularly limited, but examples of the method which can be applied include a spray coating method, a dip coating method, a flow coating method, a spin coating method, a roll coating method, a film applicator method, a screen printing method, a bar coater method, a brush coating method, and a sponge coating method.

As regards the coating method, for example, the composition can be coated on the substrate surface by a method such as brush coating, spray coating, roller coating or dip coating. The amount of the composition coated is not particularly limited, but generally, a coated amount of about 0.1 to 500 μm is considered to be sufficient. The conditions when drying the coating film can be selected according to the type of the aqueous coating material composition. For example, in the case of using an aqueous coating material composition where a substrate resin containing a hydrolyzable silyl group, a hydroxyl group and an epoxy group as essential functional group components and a metal chelate compound are contained, when heating is applied at room temperature for approximately from 1 to 72 hours, the drying may be performed at 40 to 200° C. for approximately from 1 minute to 24 hours.

The material to which the hydrophilic member can be applied is, for example, in the case of expecting the antifogging effect, a transparent material such as transparent glass substrate, transparent plastic substrate, lens, prism and mirror.

As for the glass, any glass such as soda glass, lead glass and borosilicate glass may be used. Also, according to the purpose, float sheet glass, figured glass, frosted sheet glass, mesh glass, wired glass, tempered glass, laminated glass, double glass, vacuum glass, security glass, or highly insulating low-E double glass may be used.

The usage to which the member having an antifogging effect can be applied includes a mirror such as rearview mirror for vehicles, bathroom mirror, lavatory mirror, dental mirror and road mirror; a lens such as eyeglass lens, optical lens, photographic lens, endoscopic lens, illumination lens, semiconductor lens and lens for copier; a prism; a windowpane for buildings or lookout towers; a glass for other building materials; a windowpane for various vehicles such as automobile, railway vehicle, airplane, marine vessel, submarine, snow wagon, ropeway gondola and amusement park gondola; a windshield glass for various vehicles such as automobile, railway vehicle, airplane, marine vessel, submarine, snow wagon, snowmobile, motorcycle, ropeway gondola and amusement park gondola; a glass for protective goggles, sporting goggles, protective mask shields, sporting mask shields, helmet shields or frozen food display cases; a cover glass for measurement hardware; and a film for the lamination to the surface of these articles. The most preferred usage is a glass for automobiles or building materials.

In the case of expecting the hydrophilic member to exert an antifouling effect, for example, metal, ceramic, wood, stone, cement, concrete, fiber, cloth, paper, and a combination or laminate thereof all may be suitably used as the substrate therefor, other than glass and plastic.

The usage to which the member having an antifouling effect can be applied includes a building material, a building exterior material such as outer wall and roof, a building interior material, a window frame, a windowpane, a structural member, an exterior or coat for vehicles such as automobile, railway vehicle, airplane, marine vessel, bicycle and motorcycle, an exterior, dust cover or coat for machinery and articles, an exterior or coat for traffic signs, various display devices, advertising towers, road noise barriers, railroad noise barriers, bridges and guardrails, an interior or coat for tunnels, an insulator, a solar cell cover, a heat collector cover for solar water heaters, a plastic greenhouse, a cover for vehicle lights, housing equipment, a toilet, a bathtub, a washstand, a lighting instrument, a lighting instrument cover, a kitchen utensil, a dish, a dish washer, a dish drier, a sink, a cooking oven, a kitchen hood, a ventilation fan, and a film for the lamination to the surface of these articles.

Other examples include a signboard, a traffic sign, a sound insulating wall, a plastic greenhouse, an insulator, a vehicle cover, a tent material, a reflector plate, a rain shutter door, a screen door, a solar cell cover, a heat collector cover of solar water heaters and the like, a road lamp, a pavement, outdoor lighting, a stone/tile for artificial waterfalls/artificial fountains, a bridge, a glass house, an outer wall material, a sealer between walls or glasses, a guardrail, a veranda, a vending machine, an outdoor unit of air conditioners, an outdoor bench, various display devices, a shutter, a tollgate, a fare box, a gutter, a protective cover, dust cover or coat for vehicle lamps, a coat for machinery and articles, an exterior or coat for advertising towers, a structural member, housing equipment, a toilet, a bathtub, a washstand, a lighting instrument, a kitchen utensil, a dish, a dish drier, a sink, a cooking oven, a kitchen hood, a ventilation fan, a window rail, a window flame, a tunnel inner wall, lighting in tunnels, a window sash, a radiator fin for heat exchangers, a pavement, a bathroom or lavatory mirror, a plastic greenhouse ceiling, a bathroom vanity, an automobile body, and a film or emblem which can be laminated to these articles.

This member is also applicable to a roofing material, antenna, transmission line or the like in snow countries, and in this case, an excellent property in view of preventing snow accretion is obtained.

### EXAMPLES

The present invention is described in detail below by referring to Examples, but the present invention is not limited thereto.

### Synthesis Example 1

### Synthesis of Hydrophilic Polymer (1)

Into a 500 ml-volume three-neck flask, 114 g of acrylamide, 24 g of acrylamide-3-(ethoxysilyl)propyl and 560 g of 1-methoxy-2-propanol were charged, and 4 g of dimethyl 2,2′-azobis(2-methylpropionate) was added thereto at 80° C. in a nitrogen stream. The mixture was kept at the same temperature while stirring for 6 hours and thereafter cooled to room temperature. Then, the reaction solution was poured into 4 liter of acetone, and the precipitated solid was collected by filtration. The obtained solid was washed with acetone to obtain Hydrophilic Polymer (1) shown below. The mass after drying was 130 g. By GPC (polyethylene oxide standard), this polymer was found to be a polymer having a mass average molecular weight of 25,000.

Hydrophilic Polymers (2) to (4) used in the following Examples were synthesized in the same manner and used for evaluation.

### Hydrophilic Polymer (1):

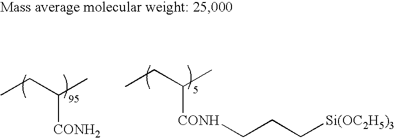

### Hydrophilic Polymer (2):

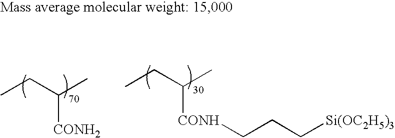

### Hydrophilic Polymer (3):

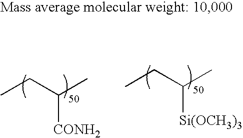

### Hydrophilic Polymer (4):

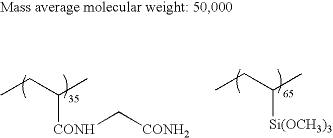

### Synthesis Example 2

### Synthesis of Hydrophilic Polymer (5)

Into a three-neck flask, 20 g of acrylamide, 3 g of 3-mercpatopropyltrimethoxysilane and 40 g of dimethylformamide were charged and heated to 60° C. in a nitrogen stream, and 0.15 g of 2,2′-azobis(2,4-dimethylvaleronitrile) was added thereto to initiate the reaction. After stirring for 5 hours, the reaction solution was returned to room temperature and poured in 1 L of ethyl acetate, as a result, a solid was precipitated. The solid was collected by filtration, thoroughly washed with ethyl acetate and dried (yield: 10 g). By GPC (polystyrene standard), this was confirmed to be a polymer having a mass average molecular weight of 6,000. The 5% aqueous solution viscosity was 3.1 cPs, and the functional group density of the hydrophilic group was 14.2 meq/g.

### Hydrophilic Polymer (5):

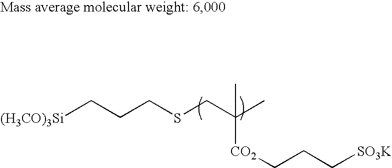

### Synthesis Example 3

### Synthesis of Hydrophilic Polymer (6)

### (Synthesis of Amide Macromonomer)

Acrylamide (70 g) and 5 g of 3-mercaptopropionic acid were dissolved in 100 g of ethanol, the temperature was elevated to 60° C. in a nitrogen atmosphere, 0.5 g of a thermal polymerization initiator 2,2-azobisisobutyronitrile (AIBN) was added thereto, and the reaction was allowed to proceed for 7 hours. After the reaction, a white precipitate was collected by filtration and thoroughly washed with methanol to obtain 50 g of a carboxylic acid-terminated prepolymer (acid value: 0.80 meq/g, molecular weight: 1,500). Subsequently, 30 g of the obtained prepolymer was dissolved in 200 g of dimethylsulfoxide, and to this solution, 12 g of glycidyl methacrylate, 0.7 g of N,N-dimethyldodecylamine (catalyst) and 0.1 g of hydroquinone (polymerization inhibitor) were added and reacted at 145° C. for 8 hours in a nitrogen atmosphere. The obtained reaction solution was added to acetone to precipitate a polymer, and the polymer was thoroughly washed to obtain 30 g of methacrylate-terminated acrylamide macromonomer (mass average molecular weight: 2,000). It was confirmed from H1-NMR (D₂O) 6.12, 5.70 ppm, olefin peak of the methacryloyl group and reduction in the acid value that a polymerizable group could be introduced into the terminal.

### (Synthesis of Hydrophilic Graft Polymer (6) Using Amide Macromonomer)

In a flask containing 100 g of dimethylsulfoxide, a solution prepared by dissolving 5 g of the macromonomer obtained above, 1 g of γ-methacryloxypropyltrimethoxysilane and 0.1 g of 2,2-azobis[2-(2-imidazolin-2-yl)propane] (VA061, trade name, produced by Wako Pure Chemical Industries, Ltd.) in 20 g of dimethylsulfoxide was added dropwise at 60° C. over 2 hours in a nitrogen atmosphere. After the completion of dropwise addition, the reaction solution was continuously heated for 6 hours and then added to acetone to precipitate a polymer, and the polymer was thoroughly washed to obtain 8 g of a hydrophilic polymer (6) having a plurality of reactive groups (molecular weight: 100,000, yield: 90%).

### Hydrophilic Polymer (6):

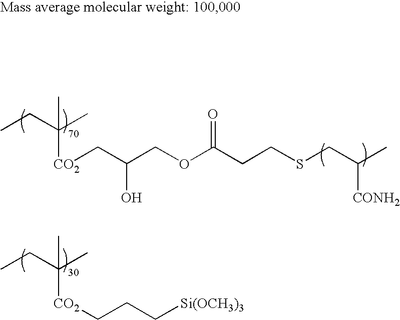

### Examples 1 to 12

The hydrophilic polymers prepared in Synthesis Examples 1 to 3 were mixed according to the blending formulation shown in Tables 1 to 2 to obtain aqueous coating material compositions. The obtained aqueous coating material compositions each was coated on a glass plate by an applicator having a clearance of 100 μm and dried at ordinary temperature for 1 day to obtain samples for evaluation. The samples were evaluated according to the following methods. The results are shown in Table 4.

### Example 13

EPOMARINE PRIMER (trademark, produced by Kansai Paint Co., Ltd., an epoxy resin-based primer coating material) was coated on a zinc phosphate-treated steel plate (thickness: 1.1 mm) to have a dry film thickness of 40 am and then dried in a room for 1 day, and EPOMARINE UNDERCOAT (trademark, produced by Kansai Paint Co., Ltd., an epoxy resin-based undercoat coating material) was coated thereon to have a dry film thickness of 20 μm and dried in a room for 1 day to prepare a substrate.

Subsequently, the aqueous coating material composition of Example 2 was coated by a bar coater on the obtained substrate to have a dry film thickness of 20 μm and then dried at 140° C. for 30 minutes to prepare a coated plate. The evaluation results are shown in Table 4.

### Comparative Example 1

The components were mixed according to the blending formulation shown in Table 3 and stirred to obtain an aqueous coating material composition. The obtained aqueous coating material composition was coated on a glass plate by an applicator having a clearance of 100 μm and dried at ordinary temperature for 1 day to obtain a sample for evaluation. The samples were evaluated according to the following methods. The results are shown in Table 5.

TABLE 1

| | Example 1 | Example 2 | Example 3 | Example 4 | Example 5 | Example 6 |
|---|---|---|---|---|---|---|
| Polymer (1) | 160 | — | — | — | — | — |
| Polymer (2) | — | 160 | — | — | — | — |
| Polymer (3) | — | — | 160 | — | — | — |
| Polymer (4) | — | — | — | 160 | — | — |
| Polymer (5) | — | — | — | — | 160 | — |
| Polymer (6) | — | — | — | — | — | 160 |
| Crosslinking agent (1) | 30 | 30 | 30 | 30 | 30 | 30 |
| Catalyst (1) | 10 | 10 | 10 | 10 | 10 | 10 |
| Water repellent | 5 | 5 | 5 | 5 | 5 | 5 |
| Pigment | 300 | 300 | 300 | 300 | 300 | 300 |
| Film-forming aid | 15 | 15 | 15 | 15 | 15 | 15 |
| Dispersant | 5 | 5 | 5 | 5 | 5 | 5 |
| Fiber | 15 | 15 | 15 | 15 | 15 | 15 |
| Thickener | 2 | 2 | 2 | 2 | 2 | 2 |
| Defoaming agent | 2 | 2 | 2 | 2 | 2 | 2 |
| Antifreezing agent | 5 | 5 | 5 | 5 | 5 | 5 |
| Plasticizer (1) | 5 | 5 | 5 | 5 | 5 | 5 |
| Solvent (1) | 600 | 600 | 600 | 600 | 600 | 600 |
| Solvent (2) | 200 | 200 | 200 | 200 | 200 | 200 |
| Dry film thickness | 30 μm | 30 μm | 30 μm | 30 μm | 30 μm | 30 μm |

In the Table, the numeral indicates parts by mass.

TABLE 2

| | | | | Example | Example | Example |
|---|---|---|---|---|---|---|
| | Example 7 | Example 8 | Example 9 | 10 | 11 | 12 |
| Polymer (1) | 160 | 160 | 160 | — | 120 | 160 |
| Polymer (2) | — | — | — | 160 | — | — |
| Polymer (3) | — | — | — | — | — | — |
| Polymer (4) | — | — | — | — | — | — |
| Polymer (5) | — | — | — | — | 40 | — |
| Polymer (6) | — | — | — | — | — | — |
| Crosslinking agent (I) | 30 | 30 | — | — | — | — |
| Catalyst (I) | — | 5 | 10 | 10 | 10 | — |
| Catalyst (2) | 10 | — | — | — | — | — |
| Catalyst (3) | — | — | — | — | — | 10 |
| Water repellent | — | 5 | 5 | 5 | 5 | 5 |
| Pigment | — | 300 | 300 | 300 | 300 | 300 |
| Film-forming aid | — | 15 | 15 | 15 | 15 | 15 |
| Dispersant | — | 5 | 5 | 5 | 5 | 5 |
| Fiber | — | 15 | 15 | 15 | 15 | 15 |
| Thickener | — | 2 | 2 | 2 | 2 | 2 |
| Defoaming agent | — | 2 | 2 | 2 | 2 | 2 |
| Antifreezing agent | — | 5 | 5 | 5 | 5 | 5 |
| Plasticizer (1) | — | 5 | 5 | 5 | 5 | 5 |
| Solvent (1) | 800 | 400 | 600 | 600 | 600 | 600 |
| Solvent (2) | — | — | 200 | 200 | 200 | 200 |
| Dry film thickness | 30 μm | 10 μm | 30 μm | 30 μm | 30 μm | 30 μm |

In the Table, the numeral indicates parts by mass.

TABLE 3

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Polymer (7) | 160 | — | 160 | — | — | — |
| Polymer (8) | — | 160 | — | 160 | — | — |
| Polymer (9) | — | — | — | — | 160 | — |
| Crosslinking agent (1) | — | — | 30 | 30 | — | 160 |
| Crosslinking agent (2) | — | — | — | — | 30 | — |
| Catalyst (1) | — | — | 10 | 10 | — | — |
| Catalyst (3) | — | — | — | — | — | 10 |
| Water repellent | 5 | 5 | 5 | 5 | 5 | 5 |
| Pigment | 300 | 300 | 300 | 300 | 300 | 300 |
| Film-forming aid | 15 | 15 | 15 | 15 | 15 | 15 |
| Dispersant | 5 | 5 | 5 | 5 | 5 | 5 |
| Fiber | 15 | 15 | 15 | 15 | 15 | 15 |
| Thickener | 2 | 2 | 2 | 2 | 2 | 2 |
| Defoaming agent | 2 | 2 | 2 | 2 | 2 | 2 |
| Antifreezing agent | 5 | 5 | 5 | 5 | 5 | 5 |
| Plasticizer (1) | 5 | 5 | 5 | 5 | 5 | 5 |
| Solvent (1) | 600 | 600 | 600 | 600 | 600 | 600 |
| Solvent (2) | 200 | 200 | 200 | 200 | 200 | 200 |
| Dry film thickness | 30 μm | 30 μm | 30 μm | 30 μm | 30 μm | 30 μm |

In the Table, the numeral indicates parts by mass.

### Polymer:

(7) PVA (molecular weight: 22,000, produced by Wako Pure Chemical Industries, Ltd.)
(8) Polyacrylamide (molecular weight: 10,000, produced by Wako Pure Chemical Industries, Ltd.)
(9) Synthesized in the same manner as Hydrophilic Polymer (1)

### Hydrophilic Polymer (9)

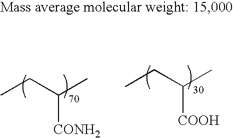

### Crosslinking Agent:

(1) Tetramethoxysilane (produced by Wako Pure Chemical Industries, Ltd.)
(2) Ethylene glycol diglycidyl ether produced by Wako Pure Chemical Industries, Ltd.)

### Catalyst:

(1) Titanium (di-i-propoxide)bis(acetylacetonate) (produced by Wako Pure Chemical Industries, Ltd.)
(2) Aluminum acetylacetonate (produced by Wako Pure Chemical Industries, Ltd.)
(3) An aqueous solution of Zircosol ZA-30 (ZrO(C₂H₃O₂)₂) produced by Daiichi Kigenso Kagaku Kogyo Co., Ltd.
Water repellent: Water dispersion-type water repellent (an emulsion-dispersed amino group-containing dimethylsiloxane compound, solid content: 50 mass %)
Pigment: White pigment, rutile titanium oxide (average particle diameter: 0.2 μm, whiteness: 97)
Film-forming aid: 2,2,4-Trimethyl-1,3-pentanediol monoisobutyrate
Dispersant: Carboxylic acid-based dispersant (solid content: 30 mass %)
Fiber: Pulp fiber (average fiber length: 0.1 mm)
Thickener: An aqueous 3 mass % hydroxyethyl cellulose solution
Defoaming agent: Mineral oil-based defoaming agent
Antifreezing agent: Ethylene glycol

### Plasticizer: (1) Sorbitol

Solvent: (1) Water, (2) ethanol,

### Evaluation of Performance

### 1) Appearance (Transparency, Gloss, Prevention of Cracking)

The appearance of coating film of each sample was evaluated with an eye. Samples were rated A when repellence, turbidity and cracking were not observed and the gloss was good, rated B when repellence, turbidity and cracking were not observed but the gloss was slightly insufficient, rated C when cracking was not present but repellency and turbidity were observed, and rated D when cracking was observed and the coating film was not uniformly formed.

### 2) Adhesive Property:

The residual state of the cured film on the substrate when after incising cross cuts in the coating film by a cutter, a pressure-sensitive adhesive tape was adhered to the surface and the pressure-sensitive adhesive tape was then peeled off, was observed with an eye. Samples were rated A when film separation was not observed, rated B when the film was partially separated, rated C when the film was seriously separated, and rated D when the curing was insufficient and the sample could not be evaluated.

### 3) Initial Hydrophilicity:

The water drop contact angle in air was measured using Drop Master 500 manufactured by Kyowa Interface Science Co., Ltd.

### 4) Water Resistance:

The hydrophilic Member in a size of 120 cm² was subjected 50 times to a rubbing treatment of moving a sponge back and force on the member while applying a load of 1 kg in water, and the residual film ratio was measured from the change in the mass between before and after the treatments.

### 5) Contamination Resistance:

A slurry prepared by suspending 5 g of carbon black (FW-200, produced by Degussa) in 95 g of water was spray-coated on the surface of the hydrophilic member in an entirely uniform manner and then dried at 60° C. for 1 hours. This sample was washed using a gauze while flowing running water and dried, and the adhering state of carbon black was evaluated by measuring the lightness difference (ΔL) (using a spectrocolorimeter, CM2600d, manufactured by MINOLTA). As the absolute value of the ΔL value is smaller, the change in the lightness is smaller and the antifouling property of the coating material is more excellent.

### 6) Scratch Resistance:

A scratch test was performed by scanning the coating film surface with a 1 mm-diameter sapphire needle while applying a load in 10-g steps starting from 10 g, and evaluating the applied load under which scratching was generated (measured by a scratch strength tester, Type 18S, manufactured by Shinto Scientific Co., Ltd.). As the applied load under which scratching was not generated is larger, the durability is better.

### 7) Abrasion Resistance:

The sample was rubbed 1,000 times with a non-woven fabric (BEMCOT, produced by Asahi Chemical Industry Co., Ltd.) while applying a load of 1 kg, and the water drop contact angle in air was measured. When the water drop contact angle (°) shows a low value even after the rubbing, the abrasion resistance is good.

### 8) Weather Resistance;

The hydrophilic member was exposed for 2,000 hours in a sunshine carbon arc lamp-type accelerated weather tester, and the sample was subjected to evaluations of 1) to 7) above in the same manner and rated according to the following criteria.

A: The performance is the same as that before exposure in all items.

B: The performance is inferior to that before exposure in one item.

C: The performance is inferior to that before exposure in two or more items.

### 9) Storage Stability:

The viscosity immediately after the preparation of each composition obtained and the viscosity after curing in a closed vessel a 60° C. for 2 weeks were measured by an E-type viscometer, and the storage stability was evaluated by calculating the increase ratio (times) of the viscosity after curing at 60° C. for 2 weeks to the viscosity immediately after the preparation. The samples were rated “A” when the increase ratio is 1.5 times or less, rated “B” when from more than 1.5 times to less than 2.0 times, and rated “C” when 2.0 times of more.

### 10) Flexibility

Each composition was coated on an aluminum sheet to a coating film thickness of 0.3 mm and dried at 150° C. for 30 minutes. This sample was tested according to JIS K5600-5-1 and evaluated with an eye. A mandrel of 2 mm in diameter was used.

A: No change.

B: Clouding was observed.

C: Cracking and separation were observed.

TABLE 4

| | Appear- | Adhesive | Initial Hydro- | Water | Antifouling | Scratch | Abrasion | Weather | Storage | |
|---|---|---|---|---|---|---|---|---|---|---|
| | ance | Property | philicity | Resistance | Property | Resistance | Resistance | Resistance | Stability | Flexibility |
| Example 1 | A | A | <5° | 100% | −1 | 200 g | 10° | A | A | A |
| Example 2 | A | A | <5° | 100% | −1.2 | 200 g | 10° | A | A | A |
| Example 3 | A | A | 15° | 100% | −2.3 | 200 g | 18° | A | A | A |
| Example 4 | A | A | 13° | 100% | −1.9 | 250 g | 17° | A | A | A |
| Example 5 | A | A | <5° | 100% | −0.8 | 150 g | 15° | A | A | A |
| Example 6 | A | A | <5° | 100% | −0.9 | 150 g | 15° | A | A | A |
| Example 7 | A | A | <5° | 100% | −1 | 150 g | 10° | A | A | B |
| Example 8 | A | A | <5° | 100% | −0.8 | 200 g | 10° | A | A | A |
| Example 9 | A | A | <5° | 100% | −0.7 | 120 g | 9° | A | A | A |
| Example 10 | A | A | <5° | 100% | −0.9 | 130 g | 7° | A | A | A |
| Example 11 | A | A | <5° | 100% | −0.8 | 120 g | 10° | A | A | A |
| Example 12 | A | A | <5° | 100% | −0.9 | 130 g | 8° | A | A | A |
| Example 13 | A | A | <5° | 100% | −1.1 | 200 g | 10° | A | A | A |

TABLE 5

| | Appear- | Adhesive | Initial Hydro- | Water | Antifouling | Scratch | Abrasion | Weather | Storage | |
|---|---|---|---|---|---|---|---|---|---|---|
| | ance | Property | philicity | Resistance | Property | Resistance | Resistance | Resistance | Stability | Flexibility |
| Comparative | A | A | 40° | 80% | −4.8 | 20 g | film peeling | C | A | B |
| Example 1 | | | | | | | | | | |
| Comparative | A | A | 20° | 30% | −4.3 | 40 g | film peeling | C | A | B |
| Example 2 | | | | | | | | | | |
| Comparative | A | A | 30° | 95% | −3.5 | 100 g | 40° | C | A | C |
| Example 3 | | | | | | | | | | |
| Comparative | A | A | 17° | 80% | −3.1 | 100 g | 45° | C | A | C |
| Example 4 | | | | | | | | | | |
| Comparative | A | A | 17° | 90% | −5.1 | 50 g | 35° | B | C | B |
| Example 5 | | | | | | | | | | |
| Comparative | A | A | 12° | 100% | −2.8 | 200 g | 30° | B | B | C |
| Example 6 | | | | | | | | | | |

According to the present invention, an aqueous coating material composition excellent in the adhesive property to various substrates and capable of giving a coating film excellent in the water resistance, antifouling property, weather resistance, scratch resistance, abrasion resistance, initial hydrophilicity and cracking prevention can be provided. Also, by virtue of the polymer having high water solubility for use in the present invention, a composition assured of excellent dispersion stability of a particle or a resin can be obtained and in turn, an aqueous coating material composition giving a coating film with good transparency and good gloss can be obtained. By virtue of incorporating a particle, interaction by the hydrophilic group of the hydrophilic polymer is reduced and a film with very high flexibility can be obtained, as a result, a hydrophilic member excellent in the scratch resistance can be produced. Furthermore, an aqueous coating material composition having a high solid material concentration can be obtained, so that the coatability of the coating material can be improved and even in the case of a thin film, a good coating film can be obtained without impairing the above-described functions. In addition, by virtue of using a metal complex for the curing catalyst, a highly versatile aqueous coating material composition with excellent storage stability and capability of being cured at ordinary temperature can be obtained.

The entire disclosure of each and every foreign patent application from which the benefit of foreign priority has been claimed in the present application is incorporated herein by reference, as if fully set forth.

What is claimed is:

1. An aqueous coating material composition, comprising:
a hydrophilic polymer that has a hydrophilic group-containing structural unit and at least one hydrolyzable silyl group represented by formula (a) in a main chain terminal or side chain of the hydrophilic polymer,
wherein the hydrophilic group-containing structural unit is contained in an amount of 30 mol % or more based on the entire hydrophilic polymer:
—Si(R¹⁰²)ₐ—(OR¹⁰¹)₃₋ₐ Formula (a)
wherein R^{10l} represents a hydrogen atom or an alkyl group;
R¹⁰² represents a hydrogen atom or a monovalent hydrocarbon group selected from the group consisting of an alkyl group, an aryl group and an aralkyl group;
a represents an integer of 0 to 2; and
when a plurality of R¹⁰¹'s or R¹⁰²'s are present, the plurality of R¹⁰¹'s or R¹⁰²'s may be the same or different, respectively.

2. The aqueous coating material composition according to claim 1,
wherein the hydrophilic polymer is a hydrophilic polymer that has at least one structure represented by formula (I) (II) or (IV): 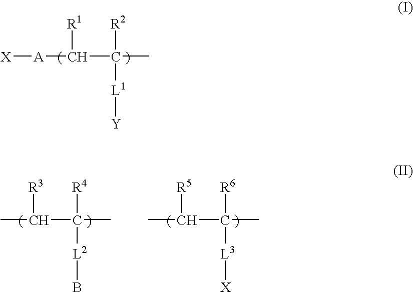
wherein R¹, R², R³, R⁴, R⁵ and R⁶ each independently represents a hydrogen atom or a hydrocarbon group;
X represents a hydrolyzable silyl group represented by formula (a);
A, L¹, L² and L³ each independently represents a single bond or a linking group;
Y represents —NHCOR⁷, —CONH₂, —CON(R⁷)₂, —COR⁷, —OH, —CO₂M, —SO₃M, —PO₃M, —OPO₃M or —N(R⁷)₃Z¹, in which R⁷ represents an alkyl group, an aryl group or an aralkyl group, M represents a hydrogen atom, an alkali metal, an alkaline earth metal or an onium, and Z¹ represents a halogen ion; and
B represents a group having a structure represented by formula (III): 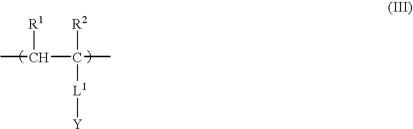
wherein R¹, R², L¹ and Y have the same meanings as in formulae (I) and (II): 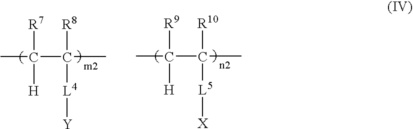
wherein R⁷, R⁸, R⁹ and R¹⁰ each independently represents a hydrogen atom or a hydrocarbon group;
L⁴ and L⁵ each independently represents a single bond or a linking group;
Y and X have the same meanings as in formulae (I) and (II); and
m2 and n2 define a compositional ratio of respective structures when m2+n2=100, provided that m2≧30.

3. The aqueous coating material composition according to claim 2,
wherein L⁵ in formula (IV) represents a single bond or a linking group having one or more structure(s) selected from the group consisting of —CONH—, —NHCONH—, —OCONH—, —SO₂NH— and —SO₃—.

4. The aqueous coating material composition according to claim 1, further comprising:
at least one of a crosslinking agent and a curing catalyst.

5. The aqueous coating material composition according to claim 4,
wherein the curing catalyst is a metal complex.

6. The aqueous coating material composition according to claim 4,
wherein the crosslinking agent is a metal alkoxide compound.

7. The aqueous coating material composition according to claim 1, further comprising:
particles.

8. The aqueous coating material composition according to claim 7,
wherein the particles have a particle diameter of from 0.01 to 10 μm.

9. The aqueous coating material composition according to claim 7,
wherein the particles are a pigment.

10. The aqueous coating material composition according to claim 1, further comprising:
an antifreezing agent.

11. The aqueous coating material composition according to claim 1,
wherein the hydrophilic group-containing structural unit accounts for 40 to 95 mol % of the entire hydrophilic polymer.

12. The aqueous coating material composition according to claim 1,
wherein the hydrophilic polymer is a hydrophilic polymer represented by formula (V): 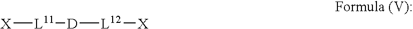
wherein X represents a hydrolyzable silyl group represented by formula (a);
L¹¹ and L¹² each independently represents a divalent linking group having three or more kinds of atoms selected from the group consisting of a carbon atom, a hydrogen atom, an oxygen atom, a nitrogen atom and a sulfur atom; and
D represents a polymer or oligomer where structural units each independently forms a repeating structure.

13. The aqueous coating material composition according to claim 6,
wherein a metal in the metal alkoxide compound is selected from the group consisting of Si, Ti, Zr and Al.

14. The aqueous coating material composition according to claim 6,
wherein the metal alkoxide compound is represented by formula (VI-1) or (VI-2):
(R⁸)ₘ-Z-(OR⁹)₄₋ₘ (VI-1)
Al—(OR⁹)₃ (VI-2)
wherein R⁸ represents a hydrogen atom, an alkyl group or an aryl group;
R⁹ represents an alkyl group or an aryl group;
Z represents Si, Ti or Zr; and
m represents an integer of 0 to 2.
